(19) United States
(12) Patent Application Publication
(10) Pub. No.: US 2015/0300226 A1
(43) Pub. Date: Oct. 22, 2015

(54) EM ENERGY APPLICATION FOR TREATING EXHAUST GASES

(71) Applicants: Shlomo Ben-Haim, London (GB); Amichai Ron, Jerusalem (IL); Elliad Silcoff, Tel Aviv (IL); Maxim Berezin, Netanya (IL); Steven R. Rogers, D. N. Emek Sorek (IL); Emanuel Elyasaf, Rehovot (IL)

(72) Inventors: Shlomo Ben-Haim, London (GB); Amichai Ron, Jerusalem (IL); Elliad Silcoff, Tel Aviv (IL); Maxim Berezin, Netanya (IL); Steven R. Rogers, D. N. Emek Sorek (IL); Emanuel Elyasaf, Rehovot (IL)

(73) Assignee: GOJI LTD., Hamilton (BM)

(21) Appl. No.: 13/981,273

(22) PCT Filed: Jan. 24, 2012
(86) PCT No.: PCT/US12/22396

§ 371 Date: Jan. 5, 2015

Related U.S. Application Data
(60) Provisional application No. 61/453,705, filed on Mar. 17, 2011.
(60) Provisional application No. 61/482,378, filed on May 4, 2011.
(60) Provisional application No. 61/435,430, filed on Jan. 24, 2011.
(60) Provisional application No. 61/528,935, filed on Aug. 30, 2011.
(60) Provisional application No. 61/436,314, filed on Jan. 26, 2011.
(60) Provisional application No. 61/473,392, filed on Apr. 8, 2011.

(51) Int. Cl. F01N 3/028; B01D 53/94; F01N 3/20; B01D 53/00

(52) U.S. Cl. CPC F01N 3/028; B01D 53/007; B01D 53/94; F01N 3/202; B01D 2259/80; F01N 2240/05

(57) ABSTRACT

An apparatus for applying electromagnetic (EM) energy to a device (e.g., an exhaust treatment device) is disclosed. The apparatus may include at least one radiating element positioned to apply EM energy to the device at a plurality of Modulation Space Elements (MSEs), at least one processor configured to determine a first spatial distribution of EM energy to be achieved during application of EM energy to the device for selectively heating a target material associated with a first portion of the device in fluid communication with exhaust gas, and cause application of EM energy, such that the first spatial distribution of EM energy is applied to the target material.

### RELATED APPLICATIONS

The present application claims the benefit of priority from the following U.S. Provisional Patent Applications: No. 61/435,430 filed Jan. 24, 2011; No. 61/436,314 filed Jan. 26, 2011; No. 61/473,392 filed Apr. 8, 2011; No. 61/453,705 filed Mar. 17, 2011; No. 61/482,378 filed May 4, 2011; No. 61/528,935 filed Aug. 30, 2011, the entire contents of each being incorporated herein by reference.

### TECHNICAL FIELD

This application relates to a device and method for applying electromagnetic (EM) energy, and more particularly, but not exclusively, to devices and methods for applying EM energy to various devices for reduction pollution emissions.

### BACKGROUND

EM waves have been used in various applications to supply energy to objects. In the case of radio frequency (RF) radiation for example, EM energy may be supplied using a magnetron. The magnetron is typically tuned to a single frequency for supplying EM energy.

Some examples of possible applications or devices for applying RF energy include combustion engines where RF energy may be used for reducing the emission of exhaust gasses, such as NOₓ, CO and for burning soot. A catalytic converter is a device used in both gasoline and diesel engines to reduce the emissions of hazardous exhaust gasses, such as NOₓ and CO by causing the oxidation of CO to CO₂ and the decomposition of NO in the presence of CO to N₂. Catalytic converters may include a converter core assembled from ceramic porous cores, for example having a honeycomb structure, with small catalytic particles used to accelerate the conversion reaction of the hazardous gases at lower temperature, such as, for example, the temperature of the exhaust gases. RF energy may be used to further increase the conversion reaction and/or to decrease the amount of catalytic particles in the converter core.

Diesel engines may also emit soot particles. These particles should be captured before the exhaust gases enter the catalytic converter, as they can be hazardous and they may also block the converter core. Modern diesel vehicles are equipped with a filter for trapping soot also known as a “DPF” (Diesel Particulate Filter). The DPF has a porous filter for trapping the soot particles and a regenerating system to burn the soot deposited on the filter to avoid filter blocking. A detector is optionally attached to the DPF to monitor the degree of blocking. When a certain blocking threshold is observed, for example by sensing an increase in the back pressure from the filter to the engine, the soot may be burned in order to regenerate the filter. Typically, the burning is done every 5-6 hours of engine operation when the amount of soot reaches approximately 500 g. In commercial DPFs, the burning is done by injecting and igniting diesel fuel for approximately 2 min.

### SUMMARY OF A FEW EXEMPLARY ASPECTS OF THE DISCLOSURE

Aspects of the present invention may include an apparatus for applying electromagnetic (EM) energy to a device (e.g., an exhaust treatment device, an emissions reduction or control device, etc.), the apparatus includes at least one radiating element positioned to apply EM energy to the device at a plurality of Modulation Space Elements (MSEs), at least one processor configured to determine a first spatial distribution of EM energy to be achieved during application of EM energy to the device for selectively heating a target material associated with a first portion of the device in fluid communication with exhaust gas, and cause application of EM energy, such that the first spatial distribution of EM energy may be applied to the target material.

Determining the first spatial distribution of EM energy may be based on feedback. The apparatus may include a feedback which may be related to at least one aspect of the device or at least one aspect of a system including the device. The feedback may be related to at least one of a temperature of the device, a value indicative of EM energy absorbable in the target material, a backpressure of the exhaust gas, a temperature associated with the exhaust gas, a composition of the exhaust gas, or a rotational speed of an engine in fluid communication with the device. The feedback may include EM feedback. The EM feedback may be indicative of EM energy absorbable by the target material.

The processor may be further configured to select a first subset of MSEs from among the plurality of MSEs, the first subset of MSEs being selected to provide the first spatial distribution of EM energy, and cause the application of EM energy at the first subset of MSEs, via the at least one radiating element. The target material may include particulate matter collected at the first portion of the device. The first portion of the device may include a filter for filtering emissions from the exhaust gas or a catalytic core for chemically converting emissions in the filter or catalytic core. The at least one radiating element may be embedded in the filter or the catalytic core. The catalytic core may include catalytic particles. The apparatus may be included in a vehicle.

The processor may be further configured to determine a second spatial distribution of EM energy to be achieved during application of EM energy for selectively heating a target material associated with a second portion of the device in fluid communication with the exhaust gas, and after a time interval subsequent to the application of EM energy at the first spatial distribution of EM energy, cause application of EM energy, via the at least one radiating element, such that the second spatial distribution of EM energy may be applied to the target material associated with the second portion of the device. The processor may be further configured to adjust the time interval based on a feedback. The feedback may be related to at least one aspect of the device or at least one aspect of a system including the device. The EM feedback may be at least in part related to at least one of a value indicative of EM energy absorbable by the target material associated with the first portion of the device or a value indicative of EM energy absorbable by the target material associated with the second portion of the device.

The processor may be further configured to select a second subset of MSEs from among the plurality of MSEs, the second subset of MSEs being selected to provide the second target spatial distribution, and after a time interval subsequent to the application of EM energy at the first spatial distribution of EM energy, cause application of EM energy at the second subset of MSEs, via the at least one radiating element. Application of the EM energy at the first spatial distribution may be conducted for a first time duration and application of the EM energy at the second spatial distribution may be conducted for a second time duration. The first time duration may be based on the feedback from the target material associated with the first portion of the device and the second time duration may be based on a feedback from the target material associated with the second portion of the device. The processor may be further configured to adjust the first and second time durations based on feedback.

In some embodiments, the application of the first and second target spatial distribution of EM energy may be achieved by exciting a propagating EM wave(s) in the device, via the radiating elements. The processor may be configured to select the first and/or second subset of MSEs to provide the propagating EM wave(s).

A processor may be further configured to determine a plurality of EM field patterns through which the EM energy may be to be applied for achieving the first and second target spatial distribution of EM energy. The processor may be further configured to determine a weight to be applied to each of the plurality of EM field patterns.

A first target spatial distribution of EM energy to be achieved during application of EM energy to the device may be determined based on a determined value indicative of EM energy absorbable in the target material associated with the first portion of the target material. Application of EM energy at the first spatial distribution may allow the target material to facilitate a chemical reaction with emissions in the exhaust gas at a first rate, and application of EM energy at the second spatial distribution may allow the target material to facilitate the chemical reaction with emissions in the exhaust gas at a second rate, the second rate being different than the first rate. The at least one of the first portion of the device or the second portion of the device may include a filter.

The target material associated with the first portion of the device or the target material associated with the second portion of the device may include emission particles trapped by the filter. The trapped emission particles may include soot particles. An amount of trapped particles may be less than 25 g.

The device may include a filter and at least one of an amount of applied EM energy associated with the first target spatial distribution and an amount of applied EM energy associated with the second target spatial distribution may be less than 50 kJ. The device may include a filter and at least one of an amount of applied EM energy associated with the first spatial distribution and an amount of applied EM energy associated with the second target spatial distribution may be less than 10 kJ. The device may include a filter, and the time interval may be less than 60 minutes. The time interval may be less than 10 minutes.

The filter may include a DPF for a vehicle, and at least one of a length of time over which the EM energy may be applied at the first subset of MSEs, an initial timing of causing application of the EM energy at the first subset of MSEs, or an amount of EM energy applied may be based in part on operation conditions of the vehicle. The operation conditions of the vehicle may include driving (operation) regimes (e.g., cold start, acceleration and cruising), speed of the vehicle, torque of the engine, emissions from the vehicle (e.g., exhaust gases), etc. A maximal soot capacity of the DPF may be substantially 100 g. The initial timing of causing application of the EM energy at the first subset of MSEs may be based in part on whether an amount of trapped particles exceeds 25 g. The length of time over which the EM energy is applied at the first subset of MSEs, the initial timing of causing application of the EM energy at the first subset of MSEs, or the amount of EM energy applied may be selected such that causing application of the EM energy at the first subset of MSEs heats the soot to 550° C. or less. Application of the EM energy at the first subset of MSEs may oxidize the soot. Application of the first target distribution of EM energy may oxidize the soot. The target material may include material for facilitating a chemical reaction with emissions in the exhaust gas. The first portion of the device may include catalytic particles and the chemical reaction may occur on a surface of the catalytic particles. The emissions may include one or more of NOx or CO. The chemical reaction of emissions at the first portion of the device may include decomposition of NOx to N2 and O2. The emissions may include one or more of CO to CO2. The chemical reaction of emissions at the first portion of the device may include decomposition of oxidation of CO to CO2.

Aspects of the present invention include an apparatus for decreasing emissions in an exhaust gas by applying EM energy to a device, the apparatus including at least one radiating element positioned to apply EM energy to the device at a plurality of Modulation Space Elements (MSEs), at least one processor configured to determine EM energy absorption characteristics associated with a target material associated with one or more portions of the device configured to interact with emissions in the exhaust gas, and control the EM energy application at one or more MSEs based on the determined EM energy absorption characteristics.

A processor may be further configured to determine a plurality of EM field patterns through which the EM energy may be to be applied for selectively heating of the target material associated with the one or more portions of the device. The processor may be further configured to determine a weight to be applied to each of the plurality of EM field patterns based on the EM energy absorption characteristics of the target material associated with the one or more portions of the device, and cause excitation of the plurality of EM field patterns at the determined weights via the at least one radiating element to apply the EM energy to the one or more portions of the device such that at least a portion of EM energy from the excited plurality of EM field patterns may be transferred to the target material associated with the one or more portions of the device. The target material may include particulate matter collected at the one or more portions of the device. The target material may include material for facilitating a chemical reaction with the emissions in the exhaust gas.

Aspects of the present invention include a method for applying EM (EM) energy to a device, the method may include determining a first spatial distribution of EM energy to be achieved during application of EM energy to the device for selectively heating a target material associated with a first portion of the device in fluid communication with exhaust gas, and causing application of EM energy, such that the first spatial distribution of EM energy may be applied to the target material. Determining the first spatial distribution of EM energy may be based on feedback. The feedback may be related to at least one aspect of the device or at least one aspect of a system including the device. The method may include selecting a first subset of MSEs from among the plurality of MSEs, the first subset of MSEs being selected to provide the first spatial distribution of EM energy, and causing the application of EM energy at the first subset of MSEs, via the at least one radiating element.

The method may include determining a second spatial distribution of EM energy to be achieved during application of EM energy for selectively heating a target material associated with a second portion of the device in fluid communication with the exhaust gas. The method may also include, after a time interval subsequent to the application of EM energy at the first subset of MSEs, causing application of EM energy at the first spatial distribution of EM energy, via the at least one radiating element, such that the second spatial distribution of EM energy may be applied to the target material associated with the second portion of the device. The method may include selecting a second subset of MSEs from among the plurality of MSEs, the second subset of MSEs being selected to provide the second target spatial distribution, and after a time interval subsequent to the application of EM energy at the first spatial distribution of EM energy, causing application of EM energy at the second subset of MSEs, via the at least one radiating element. The method may include adjusting the time interval based at least in part on at least one of a value indicative of EM energy absorbable by the target material associated with the first portion of the device or a value indicative of EM energy absorbable by the target material associated with the second portion of the device. The target material may include particulate matter collected at the first portion of the device. The target material may include material for facilitating a chemical reaction with emissions in the exhaust gas.

The method may include causing excitation of propagating EM wave(s) in the device, via the radiating elements, to achieve the application of the first and second target spatial distribution of EM energy. The method may further include selecting the first and/or second subset of MSEs in order to excite (provide) the propagating EM wave(s).

The method may include determining a plurality of EM field patterns through which the EM energy may be to be applied for achieving the first and second target spatial distribution of EM energy. The method may further include determining a weight to be applied to each of the plurality of EM field patterns.

Aspects of the present invention include a method for decreasing emissions in an exhaust gas by applying EM energy to a device, the method may include determining EM energy absorption characteristics associated with a target material associated with one or more portions of the device configured to interact with emissions in the exhaust gas, and controlling the EM energy application at one or more MSEs based on the determined EM energy absorption characteristics. The target material may include particulate matter collected at the one or more portions of the device. The target material may include material for facilitating a chemical reaction with the emissions in the exhaust gas.

Aspects of the present invention include an apparatus for applying EM energy to a device, the apparatus including at least one radiating element positioned to apply EM energy to the device at a plurality of Modulation Space Elements (MSEs), at least one processor configured to select a first subset of MSEs from among the plurality of MSEs, the first subset of MSEs being selected to apply EM energy for selectively heating a target material associated with a first portion of the device in fluid communication with exhaust gas, and cause application of EM energy at the first subset of MSEs, via the at least one radiating element. Selecting the first subset of MSEs from among the plurality of MSEs may be based on feedback. The feedback may be related to at least one aspect of the device or at least one aspect of a system including the device. The feedback may be based on at least one of a temperature of the device, a value indicative of EM energy absorbable in the target material, a backpressure of the exhaust gas, a temperature associated with the exhaust gas, a composition of the exhaust gas, or a rotational speed of an engine in fluid communication with the device.

Some aspects of the invention may involve an apparatus and method for applying EM energy to a pollution emission reduction device for reducing pollution emissions. At least one radiating element, configured to apply EM energy, may be installed or embedded in a filter (e.g., DPF) or a converter core. At least one processor may be configured to receive feedback indicative of pollution emissions and adjust the EM energy application to the device based on the received feedback. In some embodiments, the feedback may include an electro-magnetic feedback, for example indicative of EM energy absorbable in the filter or converter core.

Some aspects of the invention may include a partitioned filter for a pollution emission reduction device. Such a filter may include a DPF soot filter or a converter core.

Partitions may be included to block or substantially block gas flow from one part of the filter to another, and these partitions may or may not be constructed from a material transparent to EM energy, depending on the requirements of a particular application. Partitions reflective to EM energy may create a resonator cavity in parts of the filter. EM energy may be applied in order to burn soot particles trapped in parts of the filter. For example, one or more radiating elements may be provided in parts of the filter, and EM energy can be applied using these radiating elements. In some embodiments, the radiating elements may include near field elements or slow wave antennas.

Where the partitions may include materials transparent to EM energy, resonator cavities may be precluded in various filter parts or regions. In such cases, the spatial distribution of the EM energy application may be controlled such that EM energy may be applied to heat one or more particular part(s) while avoiding heating of other parts. For example, EM energy application may be controlled by selecting one or more MSEs to be excited in the filter (e.g., by controlling a phase of the signal applied to the radiating element(s) in each part of the filter).

In certain embodiments, an emission reduction device may be configured to burn soot trapped in filter during the operation of the vehicle. For example, the device may be designed to block exhaust gases from entering at least one selected part of a filter while applying EM energy to the selected part. Other parts, however, may be opened for gas flow and may operate as mechanical filters. The devices may also be in communication with a processor configured to block and apply EM energy to different parts of the filter to efficiently regenerate the filter during the operation of the vehicle.

In some embodiments, a pollution reduction device may include a periodic structure from which near field or evanescent EM fields may be emitted from the periodic structure. The periodic structure may have periodicity in 1 direction (e.g., a ladder or a helix), in 2 directions (e.g., a honeycomb structure) or in 3 directions (e.g., a lattice).

Some exemplary embodiments of the invention may be related to an apparatus and method for applying EM energy to clean exhaust gas (e.g., by reducing the pollution emissions in the exhaust gases). EM energy may be applied to a converter core via at least one radiating element configured to apply EM energy to the converter core via one or more MSEs. At least one processor may be configured to determine an EM feedback (e.g., a value indicative of EM energy absorbable in the converter core at the plurality of MSEs). The processor may be further configured to adjust the EM energy application via the plurality of MSEs, based on the determined feedback.

Some embodiments of the invention may be related to an apparatus and method for applying EM energy to regenerate a filter. EM energy may be applied to the filter by at least one radiating element via a plurality of MSEs. At least one processor may be configured to determine a value indicative of the EM energy absorbable in particles trapped by the filter at each of the plurality of MSEs, and adjust EM energy application via the plurality of MSEs, based on the determined value.

Some exemplary aspects of the invention may include an apparatus and method for applying EM energy to regenerate a filter. EM energy may be applied to the filter by at least one radiating element configured to apply EM energy to the filter in a plurality of application events, wherein in each application event an amount of applied energy does not exceed 50 kJ.

In another aspect one or more methods and apparatuses for regenerating a filter may include applying EM energy to the filter and adjusting a time interval between two consecutive energy application events, to be 60 minutes or less.

In yet another aspect one or more methods and apparatuses for regenerating a filter may include applying EM energy to the filter in a plurality of energy application events and adjusting each energy application event, to have duration of 30 seconds or less.

The drawings and detailed description which follow contain numerous alternative examples consistent with the invention. A summary of every feature disclosed is beyond the object of this summary section. For a more detailed description of exemplary aspects of the invention, reference should be made to the drawings, detailed description, and claims, which are incorporated into this summary by reference.

### BRIEF DESCRIPTION OF THE DRAWINGS

FIG. 1 is a diagrammatic representation of an apparatus for applying EM energy to an object, in accordance with some exemplary embodiments of the present invention;

FIG. 2 is a view of a cavity, in accordance with some exemplary embodiments of the present invention;

FIG. 3 is a flowchart of a method for applying EM energy, in accordance with some exemplary embodiments of the present invention;

FIG. 4A is a diagrammatic representation of an apparatus for applying EM energy to an object, in accordance with some exemplary embodiments of the present invention;

FIG. 4B is a diagrammatic representation of an apparatus for generating EM oscillations in an object, in accordance with some exemplary embodiments of the present invention;

FIG. 4C is a diagrammatic representation of an apparatus for generating EM oscillations in an a soot filter, in accordance with some exemplary embodiments of the present invention;

FIG. 5A is a flowchart of a method for applying a spatial EM energy distribution to energy application zone, in accordance with some embodiments of the invention;

FIG. 5B is an illustration of 3 electromagnetic field patterns in accordance with some embodiments of the invention;

FIG. 5C is a flowchart of a method for controlling aspects of EM energy application to object, in accordance with some embodiments of the invention;

FIG. 6A is a diagrammatic representation of a pollution emission reduction device, in accordance with some exemplary embodiments of the present invention;

FIG. 6B is a diagrammatic representation of a partitioned filter for a pollution emission reduction device, in accordance with some exemplary embodiments of the present invention;

FIG. 6C is a diagrammatic representation of a semi-continuous pollution emission reduction device, in accordance with some exemplary embodiments of the present invention;

FIG. 6D is a diagrammatic representation of a near field radiating element for pollution emission reduction device, in accordance with some exemplary embodiments of the present invention;

FIG. 7 is a diagrammatic representation of a periodic structure, in accordance with some exemplary embodiments of the present invention;

FIGS. 8A and 8B illustrate an exemplary pollution emission reduction device in accordance with some embodiments of the invention;

FIG. 9 is a flowchart of a method for applying EM energy to a pollution reduction device or a converter core in accordance with some embodiments of the invention;

FIGS. 10A-10B are diagrammatic representations of soot filters according with some exemplary embodiments of the invention; and

FIGS. 11-13 present simulated EM field intensity maps in accordance with some embodiments of the invention.

### DETAILED DESCRIPTION

Reference will now be made in detail to exemplary embodiments of the invention, examples of which are illustrated in the accompanying drawings. When convenient, the same reference numbers are used throughout the drawings to refer to the same or like parts.

In one respect, the invention may involve apparatus and methods for applying EM energy (EM) to devices for reducing pollution emissions from internal combustion engines or other systems. Some examples of devices for reducing pollution emissions may include: filters (e.g., Diesel Particulate Filter—DPF), catalytic converters and other devices or systems that may interact with exhaust gas. EM energy may be applied to such devices to heat target materials in the device. For example, heating and burning of soot or other particulates in a DPF filter and/or heating a core or catalytic particles in the core for accelerating the conversion reaction in a catalytic converter, for example. Some embodiments of the invention may include applying EM energy to a filter (e.g., soot filter) or a catalytic converter for purposes other than or in addition to burning of soot or other particles collected in the filter or catalytic converter. For example, some embodiments may include using applied EM energy to detect one or more characteristics associated with the device (e.g., a temperature of exhaust gases in the device, a flow rate of exhaust gases, a pressure level of the system, a size of particles collected in the device, the presence of certain compounds or chemical species, the presence of certain ions, a chemical concentration of one or more compounds (e.g., ammonia), etc). EM feedback received from the device may be associated with the at least one characteristics (aspects) associated with the device. The one or more detected characteristics of the device may be used, for example, to determine and/or control an amount of EM energy and/or spatial distribution of the EM energy to be applied to the device or to the target material within the device. In certain embodiments, the application of EM energy may be used to control aspects of a catalytic reaction in an exhaust treatment device. In other embodiments, the application of EM energy may be used to burn soot or other particles collected on portions of the device.

The term “electromagnetic” (EM) energy, as used herein, includes any or all portions of the EM spectrum, including but not limited to, radio frequency (RF), infrared (IR), near infrared, visible light, ultraviolet, etc. In one particular example, applied EM energy may include RF energy with a wavelength in free space of 100 km to 1 mm, which corresponds to a frequency of 3 KHz to 300 GHz, respectively. In some other examples, the applied EM energy may fall within frequency bands between 500 MHz to 1500 MHz or between 700 MHz to 1200 MHz or between 800 MHz-1 GHz. Microwave and ultra high frequency (UHF) energy, for example, are both within the RF range. While examples of the invention may be described herein in connection with the application of RF energy, these descriptions are illustrative and not meant to be limit the invention to any particular portion of the EM spectrum.

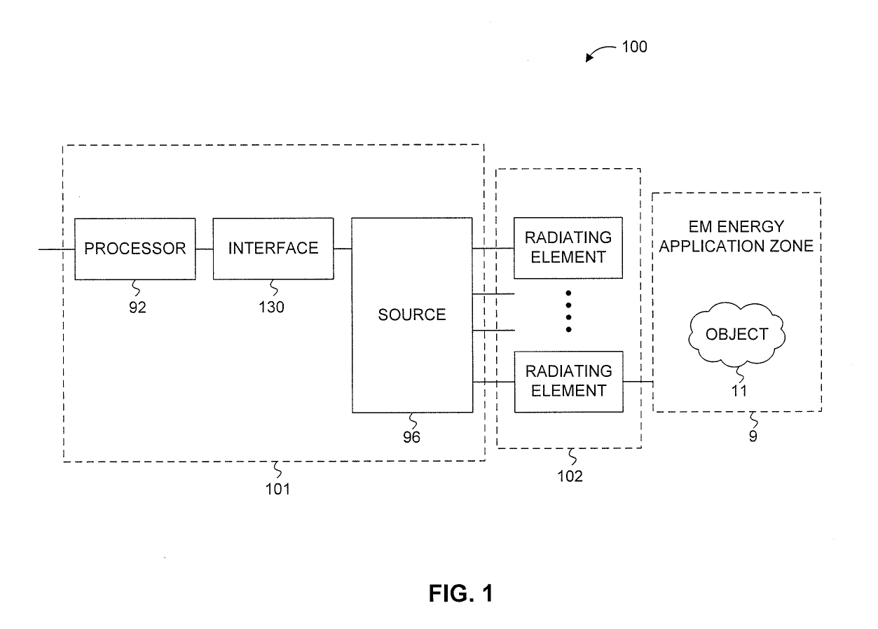

In certain embodiments, application of EM energy may occur in a filter for exhaust gases, or a catalytic converter, or any other device for reducing emissions in exhaust gases or from other sources. Application of EM energy to the exhaust gases or devices for cleaning exhaust gases may occur, for example, in an “energy application zone 9.” An exemplary energy application zone 9 is shown in FIG. 1. Energy application zone 9 may include any void, location, region, or area where EM energy may be applied. Energy application zone 9 may be hollow, or may be filled or partially filled with liquids, solids, gases, or mixtures thereof. Energy application zone 9 may include an interior of an enclosure, interior of a partial enclosure, that allows existence, propagation, and/or resonance of waves of EM radiation together with carrying out a chemical reaction, for example combustion of soot. For purposes of this disclosure, energy application zones 9 may alternatively and equivalently be referred to as “cavities.” An object may be considered “in” energy application zone 9 if at least a portion of the object is located in the zone or if some portion of the object receives EM radiation from zone 9.

In accordance with some embodiments of the invention, an apparatus or method may involve the use of at least one source configured to apply EM energy to energy application zone 9. A “source” may include any component(s) that are suitable for generating and applying EM energy. Consistent with some embodiments of the invention, EM energy may be applied to the energy application zone in the form of propagating EM waves at predetermined wavelengths or frequencies (also known as “EM radiation”). As used consistently herein, “propagating EM waves” may include resonating waves, evanescent waves, and waves that travel through a medium in any other manner. EM radiation carries energy that may be imparted to matter.

In certain embodiments, EM energy may be applied to an object 11. References to an “object” (or “object to be heated”) to which EM energy is applied are not limited to a particular form or state of the object. For example, an object may include a liquid, semi-liquid, solid, semi-solid, or gas. The object may also include composites or mixtures of matter in differing phases. In some embodiments, the object may include a target material to be heated, for example soot and/or exhaust gases, a filter, converter core and/or catalyst particles embedded in the core.

A portion of EM energy applied to energy application zone 9 may be absorbed by object 11. Other portions of the EM energy applied to energy application zone 9 may be absorbed by various other elements (e.g., deposits, such as scale, at the walls of the zone 9, structures associated with zone 9, or other EM energy-absorbing materials found in zone 9) associated with energy application zone 9.

FIG. 1 is a diagrammatic representation of an apparatus 100 for applying EM energy to an object. Apparatus 100 may include an application and control system (e.g., controller 101), an array of radiating elements or energy sources (herein the terms “antenna,” radiating element” may be used interchangeably) 102 including one or more radiating elements, and energy application zone 9. Controller 101 may be electrically coupled to one or more radiating elements 102. As used herein, the term “electrically coupled” refers to one or more direct or indirect electrical connections. Controller 101 may include processor 92, an interface 130, and an EM energy source 96. Based on an output from processor 92, source 96 may respond by generating one or more radio frequency signals to be supplied to radiating elements 102. The one or more radiating elements 102 may radiate (apply) EM energy into energy application zone 9. In certain embodiments, this energy can interact with object 11 positioned within energy application zone 9.

Processor 92 may include a general purpose or special purpose computer. Processor 92 may be configured to generate control signals for controlling EM energy source 96 via interface 130. Processor 92 may further receive measured signals from EM energy application zone 9, optionally via interface 130.

While controller 101 is illustrated for exemplary purposes as having three subcomponents, control functions may be consolidated in fewer components, or additional components may be included consistent with the desired function and/or design of a particular embodiment.

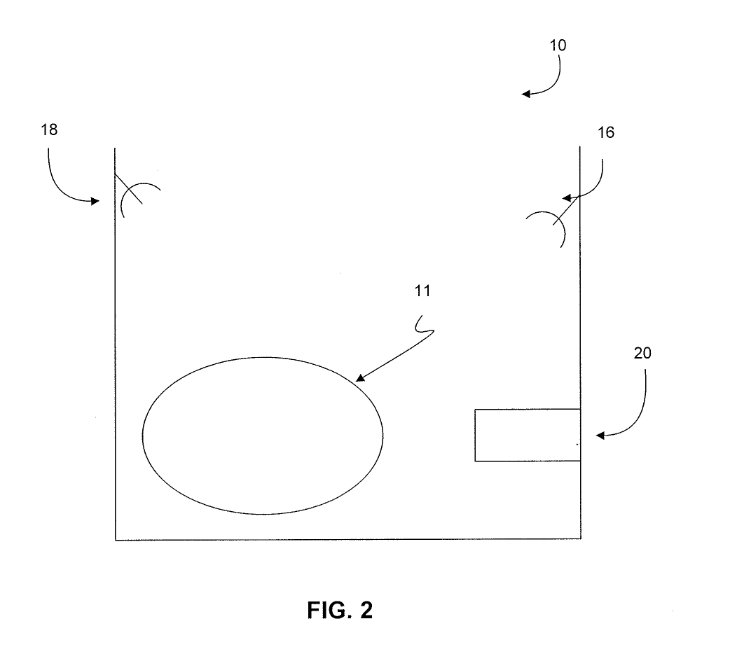

FIG. 2 shows a diagrammatic sectional view of a cavity 10, which is one exemplary embodiment of energy application zone 9. Cavity 10 may be cylindrical in shape (or take on any other suitable shape, such as semi-cylindrical, elliptical, among others) and may be made of a conductor, such as aluminum, stainless steel or any suitable metal or other electrically conductive material. In some embodiments, cavity 10 may include walls coated and/or covered with a protective coating, for example, made from materials transparent to EM energy (e.g., metallic oxides or others). In some embodiments, cavity 10 may include a converter core in an exhaust gas converter (e.g., a catalytic converter). In some embodiments the cavity may include a soot filter (e.g., a Diesel Particulate Filter (DPF)) that is designed to capture and burn soot or particulates emitted from a combustion process, e.g. a diesel combustion process (not illustrated). Cavity 10 may be resonant in a predetermined range of frequencies (e.g., within the UHF or microwave range of frequencies, such as between 300 MHz and 3 GHz, or between 400 MHz and 1 GHZ). Cavity 10 may be closed, e.g., completely enclosed (e.g., by conductor materials), bounded at least partially, or open, e.g., having non-bounded openings. The general methodology of the invention is not limited to any particular cavity shape or configuration.

FIG. 2 also shows an exemplary sensor 20 and radiating elements 16 and 18 as examples of radiating elements 102 (FIG. 1). In some embodiments, field adjusting element(s) (not illustrated) may be provided in energy application zone 9, for example, in cavity 10. Field adjusting element(s) may be adjusted to change the EM wave pattern in the cavity in a way that selectively directs the EM energy from one or more of radiating elements 16 and 18 into object 11. Additionally or alternatively, field adjusting element(s) may be further adjusted to match at least one of radiating elements 16 and 18 while acting as transmitters, and thus reduce coupling to other radiating elements acting as receivers.

In the presently disclosed embodiments, more than one feed and/or a plurality of radiating elements (e.g., radiating elements 102) may be provided. The radiating elements may be located on one or more surfaces of an enclosure defining the energy application zone 9. Alternatively or additionally, radiating elements may be located inside or outside the energy application zone 9. One or more of the radiating elements may be in contact with, in the vicinity of, or even embedded in object 11 (e.g., when the object is a liquid or gas) or embedded within a filter, or a converter core. In some embodiments, the radiating element may include the filter itself, for example, when the filter is comprised from a conductive material designed to deliver and emit EM radiation. The orientation and/or configuration of each radiating element may be different. Each radiating element may be positioned, adjusted, and/or oriented to transmit EM waves to the energy application zone 9. The radiating elements may transmit EM energy along one direction or along multiple directions. In some embodiments, different elements may transmit EM energy along different directions. Furthermore, the location, orientation, and configuration of each radiating element may be determined before applying energy to the object. Alternatively or additionally, the location, orientation, and configuration of each radiating element may be dynamically adjusted, for example, by using a processor (e.g., processor 92), during operation of the apparatus and/or between rounds of energy application. It is to be understood that the invention is not limited to radiating elements having particular structures or locations.

As represented by FIG. 1, apparatus 100 may include at least one radiating element in the form of radiating element 102 for applying of EM energy to energy application zone 9. One or more of the radiating element(s) may also be configured to receive EM energy from energy application zone 9. An “radiating element,” as used herein, may function as a transmitter, a receiver, or both.

As used herein, the terms “radiating element” and “antenna” may broadly refer to any structure from which EM energy may radiate and/or be received, regardless of whether the structure was originally designed for the purposes of transmitting (e.g., radiating) or receiving energy, and regardless of whether the structure serves any additional or different function. Consistent with some exemplary embodiments, radiating elements 102 may include an EM energy transmitter (referred to herein as “a transmitting radiating element”) that applies energy into EM energy application zone 9, an EM energy receiver (referred herein as “a receiving radiating element”) that receives energy from zone 9, or a combination of both a transmitter and a receiver. For example, a first radiating element may be configured to apply EM energy to zone 9, and a second radiating element may be configured to receive energy from the first radiating element. In some embodiments, one or more radiating elements may each serve as both receivers and transmitters. In some embodiments, one or more radiating elements may serve a dual function while one or more other radiating elements may serve a single function. So, for example, a single radiating element may be configured to both deliver EM energy to the zone 9 and to receive EM energy via the zone 9; a first radiating element may be configured to apply EM energy to the zone 9, and a second radiating element may be configured to receive EM energy via the zone 9; or a plurality of radiating elements could be used, where at least one of the plurality of radiating elements may be configured to both transmit EM energy to zone 9 and to receive EM energy via zone 9. At times, in addition to or as an alternative to transmitting and/or receiving energy, a radiating element may also be adjusted to affect the field pattern. For example, various properties of the radiating element, such as position, location, orientation, temperature, etc., may be adjusted. Different radiating element property settings may result in differing EM field patterns within the energy application zone thereby affecting energy absorption in the object. Therefore, radiating element adjustments may be varied in an energy delivery scheme.

Consistent with some of the presently disclosed embodiments, EM energy may be supplied to one or more transmitting radiating elements. Energy supplied to a transmitting radiating element may result in energy emitted (applied) by the transmitting radiating element (the emitted energy being referred to herein as “incident energy”). The incident energy may be delivered to zone 9, and may be in an amount equal to an amount of energy supplied to the transmitting radiating element(s) by a source. A portion of the incident energy may be dissipated in the object or absorbed by the object 11 (referred to herein, respectively, as “dissipated energy” or “absorbed energy”). Another portion may be reflected back to the transmitting radiating element (referred to herein as “reflected energy”). Reflected energy may include, for example, energy reflected back to the transmitting radiating element due to mismatch caused by the object and/or the energy application zone, e.g., impedance mismatch. Reflected energy may also include energy retained by the port of the transmitting radiating element (e.g., energy that is emitted by the radiating element but does not flow into the zone). The rest of the incident energy, other than the reflected energy and dissipated energy may be coupled to one or more receiving radiating elements other than the transmitting radiating element (referred to herein as “coupled energy.”). Therefore, the incident energy (“I”) supplied to the transmitting radiating element may include dissipated energy (“D”), reflected energy (“R”), and coupled energy (“T”), and may be expressed according to the relationship:

I=D+R+ΣTᵢ,

In accordance with certain aspects of the invention, the one or more transmitting radiating elements 102 may deliver EM energy into zone 9. Energy delivered by a transmitting radiating element 102 into the zone 9 (referred to herein as “delivered energy” or (d)) may be the incident energy emitted by the radiating element minus the reflected energy at the same radiating element. That is, the delivered energy may be the net energy that flows from the transmitting radiating element to the zone 9, i.e., d=I−R. Alternatively, the delivered energy may also be represented as the sum of dissipated energy and transmitted energy, i.e., d=D+T (where T=ΣTi).

In some embodiments, one or more slow wave antenna(s) may be provided in the energy application zone either in addition to or as an alternative to radiating element(s) 102. A slow-wave antenna or a near field radiating element may refer to a wave-guiding structure that possesses a mechanism that permits it to emit power along all or part of its length. The slow wave antenna or near field radiating element may comprise a plurality of slots to enable EM energy to be emitted. In some embodiments, the slow wave antenna or near field radiating element may be located in proximity to a filter or a converter core designed to apply EM energy to the filter or the converter core. One or more near field radiating elements may be aligned to one or more parts of the filter or the converter core. In some embodiments, the near field radiating element may apply EM energy to the object by emitting evanescent waves. Optionally, a periodic structure may be used as a near field radiating element, and may further be placed in an energy application zone 9, for example exhaust gas pipe or a convertor. The periodic structure may comprise periodicity in one direction (e.g., a ladder or helix) or periodicity in two directions (e.g., a honeycomb) or periodicity in 3 directions (e.g., a lattice).

In some embodiments, coupling may be formed between an evanescent EM wave (e.g., emitted from a slow wave antenna) and the object (e.g., the soot, the filter, the urea solution or exhaust gas). An EM wave that is evanescent in free space (e.g., in the vicinity of the slow wave antenna) may be non-evanescent in the object.

Radiating elements (e.g., radiating element 102) may be configured to emit (apply) energy at specifically chosen modulation space elements, referred to herein as “MSEs,” which are optionally chosen by processor 92. The term “modulation space” or “MS” is used to collectively refer to all controllable parameters that may affect a field pattern in the energy application zone and all combinations thereof. In some embodiments, the “MS” may include possible controllable components that may be used and their potential settings (absolute and/or relative to others) and adjustable parameters associated with the components. For example, the “MS” may include a plurality of variable parameters, the number of radiating elements, their positioning and/or orientation (if modifiable), useable bandwidth of frequencies, a set of all useable frequencies and any combinations thereof, power settings, phases, etc. The MS may have any number of possible variable parameters, ranging between one parameter only (e.g., a one dimensional MS limited to frequency only or phase only—or other single parameter), two or more dimensions (e.g., varying frequency and amplitude or varying frequency and phase together within the same MS), or more.

Each variable parameter associated with the MS is referred to as an “MS dimension.” By way of example, a three dimensional modulation space, with three dimensions designated as frequency (F), phase (P), and amplitude (A). That is, frequency, phase, and amplitude (e.g., an amplitude difference between two or more waves being transmitted at the same time) of the EM waves are modulated during energy application, while all the other parameters may be predetermined and fixed during energy delivery, i.e., the modulation space is depicted in three dimensions for ease of discussion only. The MS may have any number of dimensions, e.g., one dimension, two dimensions, four dimensions, n dimensions, etc. In one example, a one dimensional modulation space may provide MSEs that differ one from the other only by frequency.

The term “modulation space element” or “MSE,” may refer to a specific set of values of the variable parameters in MS. Therefore, the MS may also be considered to be a collection of all possible MSEs. For example, two MSEs may differ one from another in the relative amplitudes of the energy being supplied to a plurality of radiating elements. For example, an MSE in a three-dimensional MS may have a specific frequency F(i), a specific phase P(i), and a specific amplitude A(i). If even one of these MSE variables changes, then the new set defines another MSE. For example, (3 GHz, 30°, 12 V) and (3 GHz, 60°, 12 V) are two different MSEs, although only the phase component is different.

Differing combinations of these MS parameters may lead to differing field patterns across the energy application zone and differing energy distribution patterns in the object. A plurality of MSEs that can be executed sequentially or simultaneously to excite a particular field pattern in the energy application zone may be collectively referred to as an “energy delivery scheme.” For example, an energy application scheme may consist of three MSEs: (F(1), P(1), A(1)); (F(2), P(2), A(2)) (F(3), P(3), A(3)). Such an energy application scheme may result in applying the first, second, and third MSE to the energy application zone.

The invention is not limited to any particular number of MSEs or MSE combinations. Various MSE combinations may be used depending on the requirements of a particular application and/or on a desired energy transfer profile, and/or given equipment, e.g., cavity dimensions. The number of options that may be employed could be as few as two or as many as the designer desires, depending on factors such as intended use, level of desired control, hardware or software resolution and cost.

In certain embodiments, there may be provided at least one processor (e.g., processor 92). As used herein, the term “processor” may include an electric circuit that performs a logic operation on input or inputs. For example, such a processor may include one or more integrated circuits, microchips, microcontrollers, microprocessors, all or part of a central processing unit (CPU), graphics processing unit (GPU), digital signal processors (DSP), field-programmable gate array (FPGA) or other circuit suitable for executing instructions or performing logic operations. The at least one processor may be coincident with or may be part of controller 101.

The instructions executed by the processor may, for example, be pre-loaded into the processor or may be stored in a separate memory unit such as a RAM, a ROM, a hard disk, an optical disk, a magnetic medium, a flash memory, other permanent, fixed, or volatile memory, or any other mechanism capable of storing instructions for the processor. The processor(s) may be customized for a particular use or may be configured for general-purpose use and can perform different functions by executing different software.

If more than one processor is employed, all may be of similar construction, or they may be of differing constructions electrically connected or disconnected from each other. They may be separate circuits or integrated in a single circuit. When more than one processor is used, the one or more processors may be configured to operate independently or collaboratively. They may be coupled electrically, magnetically, optically, acoustically, mechanically or by other means permitting them to interact.

The at least one processor may be configured to cause EM energy to be applied to zone 9 via one or more radiating elements, for example across a series of MSEs (a plurality of MSEs), in order to apply EM energy at each such MSE to object 11. For example, processor 92 may be configured to regulate one or more components of controller 101 in order to cause the energy to be applied.

In certain embodiments, the at least one processor may be configured to determine an EM feedback, e.g., a value indicative of energy absorbable by the object at each of a plurality of MSEs. The EM feedback may be MSE dependant. This may occur, for example, using one or more lookup tables, by pre-programming the processor or memory associated with the processor, and/or by testing an object in an energy application zone to determine its absorbable energy characteristics. One exemplary way to conduct such a test is through a sweep.

As used herein, a sweep may include, for example, the transmission over time of energy at more than one MSE. For example, a sweep may include the sequential transmission of energy at multiple MSEs in one or more contiguous MSE band; the sequential transmission of energy at multiple MSEs in more than one non-contiguous MSE band; the sequential transmission of energy at individual non-contiguous MSEs; and/or the transmission of synthesized pulses having a desired MSE/power spectral content (e.g., a synthesized pulse in time). The MSE bands may be contiguous or non-contiguous. Thus, during an MSE sweeping process, the at least one processor may regulate the energy supplied to the at least one radiating element to sequentially apply EM energy at various MSEs to zone 9, and to receive feedback which serves as an indicator of the energy absorbable by object 11. While the invention is not limited to any particular measure of EM feedback, some EM feedbacks may be indicative of energy absorption in the object, are discussed below.

During the sweeping process, EM source 96 (e.g., via a directional coupler) may be regulated to receive EM energy reflected and/or coupled at radiating element(s) 102, and to communicate the measured energy information (e.g., information pertaining to and/or related to and/or associated with the measured energy) back to processor 92 via interface 130, as illustrated in FIG. 1. Processor 92 may then be regulated to determine an EM feedback (e.g., a value indicative of energy absorbable by object 11) at each of a plurality of MSEs based on the received information. Consistent with some of the presently disclosed embodiments, an EM feedback indicative of the absorbable energy may include a DR associated with each of a plurality of MSEs. As referred to herein, a “dissipation ratio (DR)” (or “absorption efficiency” or “power efficiency”), may be defined as a ratio between EM energy absorbed by object 11 and EM energy supplied into the transmitting radiating element. In some embodiments, a “dissipation ratio (DR)”, may be defined as a ratio between EM energy absorbed by object 11 and EM energy delivered into EM energy application zone 9.

Energy that may be dissipated or absorbed by an object is referred to herein as “absorbable energy” or “absorbed energy”. Absorbable energy may be an indicator of the object's capacity to absorb energy or the ability of the apparatus to cause energy to dissipate in a given object (for example, an indication of the upper limit thereof). In some of the presently disclosed embodiments, absorbable energy may be calculated as a product of the incident energy (e.g., maximum incident energy) supplied to the at least one radiating element and the dissipation ratio. Reflected energy (e.g., the energy not absorbed or transmitted) may, for example, be an EM feedback indicative of energy absorbable by the object. By way of another example, a processor might calculate or estimate absorbable energy based on the portion of the incident energy that is reflected and the portion that is coupled. That estimate or calculation may serve as a value indicative of absorbed and/or absorbable energy.

During an MSE sweep, for example, the at least one processor may be configured to control a source of EM energy such that energy is sequentially supplied to an object at a series of MSEs. The at least one processor might then receive a signal indicative of energy reflected at each MSE and, optionally, also a signal indicative of the energy coupled to other radiating elements at each MSE. Using a known amount of incident energy supplied to the radiating element and a known amount of energy reflected and/or coupled (e.g., thereby indicating an amount of energy absorbed at each MSE), an absorbable energy indicator may be calculated or estimated. Alternatively, the processor might simply rely on an indicator of reflection and/or transmission as a value indicative of absorbable energy.

In some of the presently disclosed embodiments, a dissipation ratio (DR) may be calculated using formula (1):

DR(Pin−Prf−Pcp)/Pin (1)

where: Pin represents the EM energy and/or power supplied into zone 9 by radiating elements 102, Prf represents the EM energy and/or power reflected/returned at those radiating elements that function as transmitters, and Pcp represents the EM energy and/or power coupled at those radiating elements that function as receivers. DR may be a value between 0 and 1, and thus may be represented by a percentage.

For example, consistent with an embodiment which is designed for three radiating elements 1, 2, and 3, processor 92 may be configured to determine input reflection coefficients S11, S22, and S33 and the transfer coefficients may be S12=S21, S13=S31, S23=S32 based on a measured power and/or energy information during the sweep. Accordingly, the dissipation ratio DR corresponding to radiating element 1 may be determined based on the above mentioned reflection and transmission coefficients, according to formula (2):

DR=1−(IS11I2+IS12I2+IS13I2). (2)

The value indicative of the absorbable energy may further involve the maximum incident energy associated with a power amplifier (not illustrated) of source 96 at the given MSE. As referred herein, a “maximum incident energy” may be defined as the maximal power that may be provided to the radiating element at a given MSE throughout a given period of time. Thus, one alternative value indicative of absorbable energy may be the product of the maximum incident energy and the dissipation ratio. These are just two examples of values that may be indicative of absorbable energy which could be used alone or together as part of control schemes implemented in processor 92. Alternative indicators of absorbable energy may be used, depending for example on the structure employed and the application.

In certain embodiments, the at least one processor may also be configured to cause energy to be supplied to the at least one radiating element in at least a subset of a plurality of MSEs. Energy applied to the zone at each of the subset of MSEs may be a function of the absorbable energy value at the corresponding MSE. For example, energy transmitted to the zone at MSE(i) may be a function of the absorbable energy value at MSE(i). The energy supplied to at least one radiating element 102 at each of the subset of MSEs may be determined as a function of the absorbable energy value at each MSE (e.g., as a function of a dissipation ratio, maximum incident energy, a combination of the dissipation ratio and the maximum incident energy, or some other indicator). In some embodiments, the subset of the plurality of MSEs and/or the energy applied to the zone at each of the subset of MSEs may be determined based on or in accordance with a result of absorbable energy information (e.g., absorbable energy feedback) obtained during an MSE sweep (e.g., at the plurality of MSEs). That is, using the absorbable energy information, the at least one processor may adjust energy supplied at each MSE such that the energy at a particular MSE may in some way be a function of an indicator of absorbable energy at that MSE. The functional correlation may vary depending upon application and/or a desired target effect, e.g., a more uniform spatial energy distribution may be desired across object 11. The invention is not limited to any particular scheme, but rather may encompass any technique for controlling the energy supplied by taking into account an indication of absorbable energy.

In certain embodiments, the at least one processor may be configured to cause energy to be supplied to the at least one radiating element in at least a subset of the plurality of MSEs. The subset of MSEs at which energy is applied may be selected based on various criteria. For example, in some embodiments, the subset of MSEs may be selected such that energy application is concentrated spatially within a certain region or regions of the energy application zone (e.g., to obtain a target spatial distribution of EM energy). In other embodiments, the subset of MSEs may be selected such that energy application may result in substantially uniform energy absorption by an object in the energy application zone. Further, in some embodiments, energy applied to the zone at each of the subset of MSEs may be inversely related to the EM feedback (e.g., value indicative of energy absorbable) at the corresponding MSE. Such an inverse relationship may involve a general trend (e.g., when an EM feedback in a particular MSE subset (i.e., one or more MSEs) tends to be relatively high, the actual incident energy at that MSE subset may be relatively low). When an EM feedback in a particular MSE subset tends to be relatively low, the incident energy may be relatively high. This substantially inverse relationship may be even more closely correlated. For example, the applied energy may be set such that its product with the EM feedback (i.e., the absorbable energy by object 11) is substantially constant across the MSEs applied.

Some exemplary energy delivery schemes may lead to more spatially uniform energy absorption in the object. As used herein, “spatial uniformity” may refer to a condition where the absorbed energy across the object or a portion (e.g., a selected portion) of the object that is targeted for energy application is substantially constant (for example per volume unit or per mass unit). In some embodiments, the energy absorption is considered “substantially constant” if the variation of the dissipated energy at different locations of the object is lower than a threshold value. For instance, a deviation may be calculated based on the distribution of the dissipated energy in the object, and the absorbable energy is considered “substantially constant” if the deviation between the dissipation values of different parts of the object is less than 50%. Because in many cases spatially uniform energy absorption may result in spatially uniform temperature increase, consistent with the presently disclosed embodiments, “spatial uniformity” may also refer to a condition where the temperature increase across the object or a portion of the object that is targeted for energy application is substantially constant. The temperature increase may be measured by a sensing device, for example a temperature sensor provided in zone 9. In some embodiments, spatial uniformity may be defined as a condition, where a given property of the object is uniform or substantially uniform after processing, e.g., after a heating process. Examples of such properties may include temperature, pressure, hazardous compounds emissions, load and torque of an engine etc.

In order to achieve control over the spatial distribution of energy absorption in an object or a portion of an object (e.g. to achieve spatial uniformity or controlled spatial non-uniformity), processor 92 may be configured to hold substantially constant the amount of time at which energy is supplied to radiating elements 102 at each MSE, while varying the amount of power supplied at each MSE as a function of the absorbable energy value. In some embodiments, controller 101 may be configured to cause the energy to be supplied to the radiating element at a particular MSE or MSEs at a power level substantially equal to a maximum power level of the device and/or the amplifier at the respective MSE(s).

Alternatively or additionally, processor 92 may be configured to vary the period of time during which energy is applied to each MSE as a function of the EM feedback at each MSE or other feedback. At times, both the duration and power at which each MSE is applied are varied as a function of the EM feedback at that MSE. Varying the power and/or duration of energy supplied at each MSE may be used to cause substantially uniform energy absorption in the object or to have a controlled spatial distribution of energy absorption, for example, based on feedback (e.g., feedbacks other than EM feedbacks) from the object at each applied MSE.

Because absorbable energy can change based on factors including object temperature, in some embodiments, it may be beneficial to regularly update EM feedbacks and adjust energy application based on the updated EM feedbacks. These updates can occur multiple times a second, or can occur every few seconds or longer, depending on the requirements of a particular application.

In accordance with an aspect of some embodiments of the invention, the at least one processor (e.g., processor 92) may be configured to determine a desired and/or target energy absorption level at each of a plurality of MSEs and adjust energy supplied from the radiating element at each MSE in order to obtain the target energy absorption level at each MSE. For example, processor 92 may be configured to target a desired energy absorption level at each MSE in order to achieve or approximate substantially uniform energy absorption across a range of MSEs. Alternatively, processor 92 may be configured to provide a target energy absorption level at each of a plurality of object portions, which collectively may be referred to as an energy absorption profile across the object. An absorption profile may include uniform energy absorption in the object, non-uniform energy absorption in the object, differing energy absorption values in differing portions of the object, substantially uniform absorption in one or more portions of the object, or any other desirable pattern of energy absorption in an object or portion(s) of an object.

In some embodiments, the at least one processor may be configured to adjust energy supplied to the radiating element at each MSE in order to obtain a desired target energy effect in the object, e.g., to obtain a target spatial EM energy distribution, for example: a different amount of energy may be provided to different parts and/or regions of the object or the filter or the converter (e.g., a different amount of energy may be applied to different location within the filter).

Obtaining Feedback

One or more sensor(s) (or detector(s)) 20 may be used to sense, or detect, transmit, relate, derive and/or determine “feedback” (described in more detail below and referred to herein interchangeably as “feedback” and “feedback information”) relating to object 11 and/or to the energy application process and/or the energy application zone or any other object, device or location described herein. At times, one or more radiating elements, e.g., radiating element 16 or 18, may be used as sensors 20 (e.g., when acting as receivers). The feedback information may include EM feedback (e.g., EM signals may be detected).

Sensor(s) 20 may be installed, for example, in or around energy application zone 9 or in or around object 11. As used herein, the words “sensor” and “detector” refer generally to a device configured to detect a certain aspect of the device's environment and/or of an object in the device's environment. Suitable sensors 20 may detect any environmental aspect that may be useful in the determination and/or regulation of EM energy applied to the object 11. For example, sensor 20, may detect, collect, process, send, and/or receive information relating to “feedback,” as described below. Sensor or sensors 20 may also detect, collect, process, send, and/or receive information that does not relate to feedback (e.g., timing of various processes, various environmental conditions not related to the application of EM energy). Sensors 20 may include thermocouples or an IR sensors.

As used herein, the term “feedback” generally refers to information in any suitable form (e.g., in the form of signals, electronic or otherwise, code, data, digital or analog, etc.) relating to any aspect of the environment of object 11 (including object 11 itself) that may or may not be affected by or affect by applications of EM energy. Feedback may include or be derived from various parameters and/or information that is not necessarily associated with the application of EM energy (referred to herein simply as “feedback”). Alternatively, feedback may include feedback that is received via EM radiation or via apparatuses, methods relating to the application and/or collection of EM radiation (referred to herein as “EM feedback”). As used herein, EM feedback may include any received signal or any value calculated based on a receive signal(s), which may be indicative of the dielectric response of the cavity and/or the object to the applied RF energy. In this case the EM feedback may include various parameters and/or information associated with the application, reflection, transmission and/or absorption of EM energy by object 11, apparatus 100, the environment in proximity to any of sensor 20, object 11, or apparatus 100 or any other device or entity described herein. Alternatively or in addition, feedback may include various parameters and/or information that is not necessarily associated with the application of EM energy (referred to herein simply as “feedback”). Feedback sensed, detected, transmitted, related, derived and/or determined by sensor 20 may be continuous or may be sensed, detected, transmitted, related, derived and/or determined in discreet increments or events.

Feedback may include, for example, temperatures or information relating to a temperature of object 11, apparatus 100, the environment in proximity to any of the sensor 20, the object 11, and the apparatus 100 or any other device or entity described herein. Feedback may also include, for example, materials parameters relating to object 11, apparatus 100, the environment in proximity to any of the sensor 20, the object 11, and the apparatus 100 or any other device or entity described herein, such as materials parameters, for example, that may relate to a change of state, a decrease/increase in any intrinsic or extrinsic property, change in mass, weight, density, size, color, chemical constitution, shape (e.g., aspect ratio, volume, etc.), conductivity, a state or states of a chemical reaction and/or chemical reactivity. The feedback may relate to fluid properties relating to the object 11, and the apparatus 100 or any other device or entity described herein. Such fluid properties may include, for example, a gas or liquid flow rate, humidity, pressure (e.g., a barometer, back pressure of an exhaust gas in or from an engine), pH, presence of particles or ions in the fluid, etc.

Any of the above-described forms of feedback may relate, for example, to an amount or change in amount (e.g., mass or weight) of particulate collected at a location (specific or general), filter, catalytic converter and/or other device. The above-described feedback may also relate to, for example, a temperature of the particulate collected at the location (specific or general), filter, catalytic converter and/or other device, or any other suitable property of the particulate. Alternatively, or in addition, the above-described feedback may also relate to a composition of a component in an environment of object 11, for example, the feedback may relate to a composition of a gas included in object 11. The gas may include, for example, an exhaust gas from a combustion engine, and the composition included in the feedback may relate to an amount of exhaust or other specific component of the exhaust gas. The feedback may also relate to any other property described herein (e.g., temperature, density, etc.).

EM feedback may include any received signal or any value calculated based on a receive signal(s), for example from sensor(s) 20. EM feedback may be MSE-dependent, for example, and may include signals, the values of which vary over different MSEs. EM feedback may relate to, for example, a dissipation ratio (referred to herein as “DR”) of the object 11 or other entity in the vicinity of the object 11. The value indicative of absorbable energy may or may not relate to the DR. For example, the DR and/or the EM feedback may relate to an incident power of EM energy, a reflected power of EM energy, a coupled power of EM energy and/or a ratio there between (e.g., such as via a reflection coefficient or a transfer coefficient). EM feedback may also or alternatively include, for example, input and output power levels, scattering parameters (a/k/a S parameters) and values derivable from the S parameters and/or from the power levels, for example, input impedance of one or more radiating element, dissipation ratio, time or MSE derivative of any of them, or any other value that may be derivable from the received signals.

EM feedback may relate to, for example, use and/or construction of a loss profile. A loss profile may include any representation of the ability of an energy application zone 9 or object 11 to absorb energy, such as EM energy applied from apparatus 100. A loss profile may include a spatial distribution within an object, a cavity or a device (and a portion thereof). A loss profile may be represented, for example, by a matrix, table or other 2D or 3D representation or map of a cavity, wherein each portion of the map may be annotated (e.g., using notations, cross-hatching, colors, etc.) in accordance with the ability of that portion to absorb energy. In the case of an energy application zone (e.g., zone 9), a loss profile may include such representation across its volume with or without an object 11. In the case of a pollution reduction device, a loss profile may include such representation across its volume or across a target material associated with one or more portions of the device.

For example, the loss profile may be represented in various ways in order to convey information about the distribution of energy loss in the energy application zone. For example, the loss profile may be represented using imaging, analytics, numerics, calculation, simulation, tablature, or any other mechanism capable of reflecting a distribution or partial distribution of energy loss.

The at least one processor 92 may be configured to calculate the distribution of energy absorption characteristics based on at least one of a discretization of the energy application zone, an EM field intensity associated with each of the plurality of field patterns, and/or power dissipated in the energy application zone at each of the plurality of field patterns.

As the energy application zone may be discretized, the loss profile may be discretized and mapped to sub regions of the discretized energy application zone.

Controlling EM Energy Application Based on Feedback

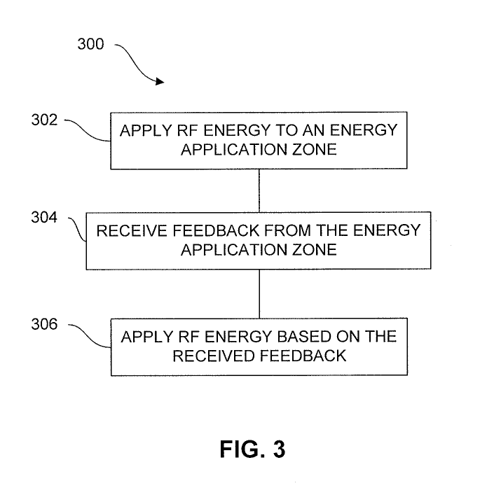

Method 300 for applying EM energy, e.g., Radio Frequency (“RF”) energy—EM energy from radiation in the RF range) to an energy application zone (e.g., energy application zone 9, FIG. 1) is presented in the flowchart in FIG. 3. EM energy may be applied to the energy application zone (e.g., zone 9), at step 302, via one or more radiating elements. In some embodiments, low amounts of EM energy may initially be applied at one or more MSEs. Low EM amounts of energy may be defined as amounts of energy applied to the energy application zone that are too low to process an object (e.g., object 11) placed in the zone. For example, the low amounts of energy may not be sufficient to process the object 11. As use herein an amount of energy sufficient to process an object is defined as an amount of energy, that when applied to the object may change at least one property of the object in at least a portion of the object (e.g., to cook a food item, thaw frozen object, cause or accelerate chemical reaction, heat an object or device in order to clean the object or device, such as by removing collected particulate, apply EM energy to an agent in or facilitator or a chemical reaction in order to alter a rate of the chemical reaction, etc.). Low amounts of energy may be applied, for example, by applying low EM power from the EM source (e.g., source 96) or by applying a high power for short periods of time. Alternatively, EM energy application in step 302 may be conducted in energy levels sufficient to process an object in the energy application zone 9. The EM energy application in step 302 may be conducted by sweeping over a plurality of MSEs, for example, by transmission over time of energy at more than one MSE. A processor (e.g., processor 92) may control the EM energy application by sweeping over a plurality of MSEs and assigning a constant (e.g., low) amount of energy to be applied at each MSE.

The processor may than receive a feedback (e.g., EM feedback) from the energy application zone or from a system comprising the energy application zone, at step 304. The feedback may be received from one or more sensors, for example a thermometer placed in zone 9. An EM feedback may be a result of the EM energy applied at step 302. The EM feedback may be received from one or more sensors and/or detectors configured to measure EM feedback values in the energy application zone 9 (e.g., sensor 20). The EM feedback may include any type of feedback discussed above. Various EM feedback values may be received by the processor (e.g., processor 92) during application of EM energy at various MSEs, for example during sweeping over a plurality of MSEs. The processor 92 may be configured to associate each EM feedback value with a corresponding MSE. Additionally or alternatively, other feedback values (not related to EM feedback) may be received during application of EM energy at various MSEs, for example during sweeping over a plurality of MSEs. Each of the received feedback (or EM feedback) values may be associated with a particular MSE.

The processor may further be configured to apply EM energy based on the received feedback, at step 306. For example, the processor may cause application of EM energy at selected MSEs (e.g., MSEs associated with a feedback values lower or higher than a threshold). Additionally or alternatively, the processor may adjust the EM energy amounts applied at each MSE as a function of the EM feedback value at that MSE. In some exemplary embodiments, the processor may apply EM energy at each MSE in an amount inversely related to or nearly inversely related to the dissipation ratio value at that MSE.

In some embodiments, the at least one processor may determine a weight, used for supplying a determined amount of energy at each MSE. Determining the weight may include determining a power level and/or time duration for each EM energy application. In some embodiments, such weights may be determined as a function of the EM feedback (e.g., value indicative of absorbable energy). For example, an amplification ratio of an amplifier may be changed with the EM feedback values received from zone 9 at each MSE. In some embodiments, the processor may use the maximum available power at each MSE, which may vary between MSEs. This variation may be taken into account when determining the respective durations at which the energy is supplied at maximum power at each MSE. In some embodiments, the at least one processor (e.g., processor 92) may determine both the power level and time duration for supplying the energy at each MSE.

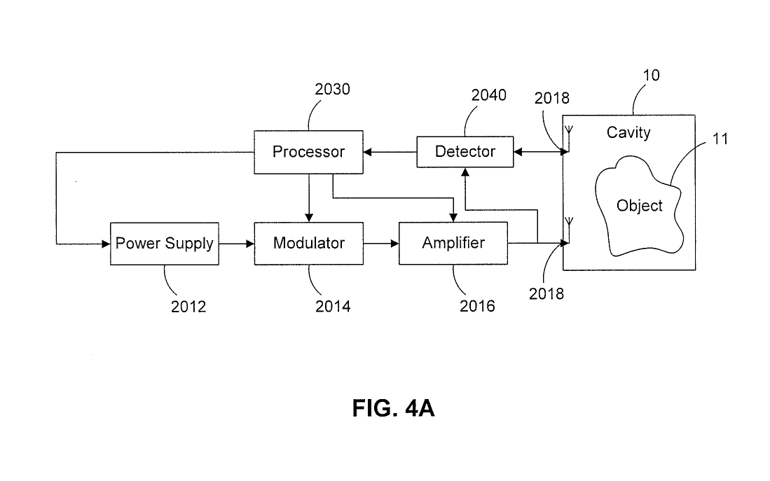

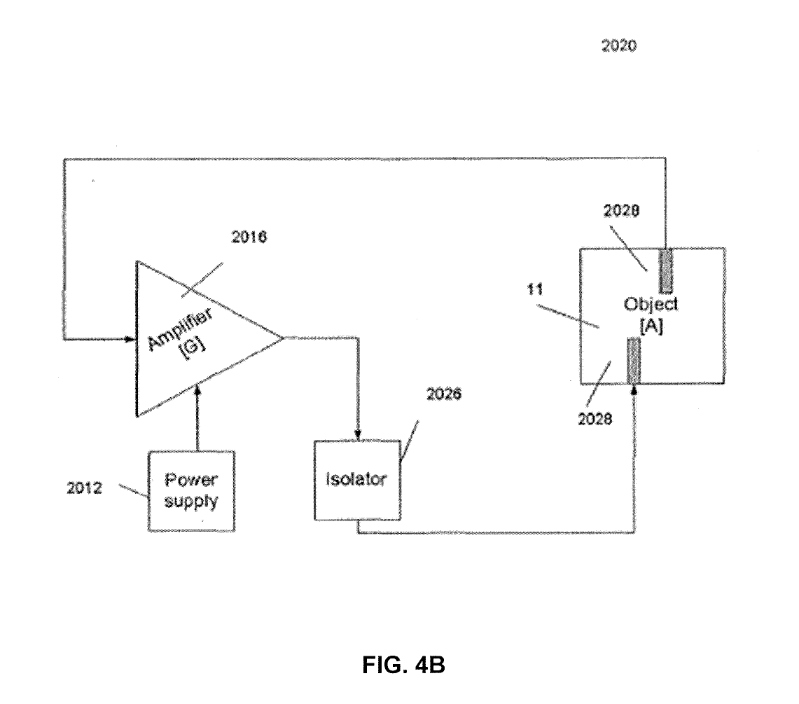

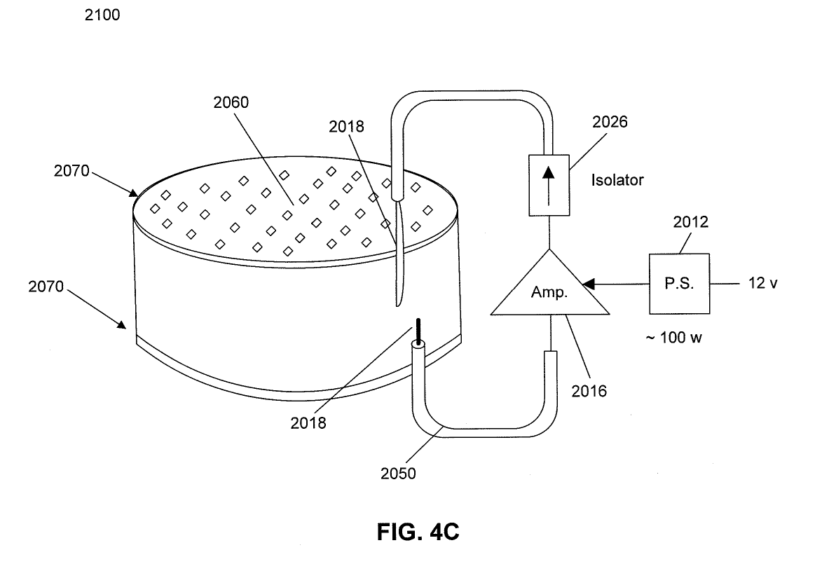

FIG. 4A provides a diagrammatic representation of an exemplary apparatus 100 for applying EM energy to an object, in accordance with some embodiments of the present invention. In accordance with some embodiments, apparatus 100 may include a processor 2030 which may regulate modulations performed by modulator 2014. In some embodiments, modulator 2014 may include at least one of a phase modulator, a frequency modulator, and an amplitude modulator configured to modify the phase, frequency, and amplitude of the AC waveform, respectively. Processor 2030 may alternatively or additionally regulate at least one of location, orientation, and configuration of each radiating element 2018, for example, using an electro-mechanical device. In some embodiments, the processor may be configured to select at least one radiating element from a plurality of radiating elements. The processor may be further configured to connect or disconnect the at least one selected radiating element. Connecting or disconnecting may be performed by mechanical means (e.g., moving or shifting a waveguide or a coaxial cable from one radiating element to the other) or by electric switching between the selected elements (e.g., by providing zero power to the disconnected radiating element), or by any other suitable method or configuration for switching between one or more radiating elements. Such an electromechanical device may include a motor or other movable structure for rotating, pivoting, shifting, sliding or otherwise changing the orientation and/or location of one or more of radiating elements 2018. Alternatively or additionally, processor 2030 may be configured to regulate one or more field adjusting elements located in the energy application zone, in order to change the field pattern in the zone.

In some embodiments, apparatus 100 may involve the use of at least one source may be configured to supply EM energy to at least one radiating element. By way of example, and as illustrated in FIG. 4A, the source may include one or more of a power supply 2012 configured to generate EM waves that carry EM energy. For example, power supply 2012 may be a magnetron configured to generate high power microwave waves at a predetermined wavelength or frequency. Alternatively, power supply 2012 may include a semiconductor oscillator, such as a voltage controlled oscillator, configured to generate AC waveforms (e.g., AC voltage or current) with a constant or varying frequency. AC waveforms may include sinusoidal waves, square waves, pulsed waves, triangular waves, or another type of waveforms with alternating polarities. Alternatively, a source of EM energy may include any other power supply, such as EM field generator, EM flux generator, solid state amplifier or any mechanism for generating vibrating electrons.

Apparatus 2020, for generating EM oscillations in an object is illustrated in FIG. 4B, in accordance with some embodiments of the present invention. In some embodiments, apparatus 2020 may be configured to supply EM oscillating waves to object 11 without the use of an oscillator. Object 11 may be a filter (e.g., DPF), exhaust gas in the filter, converter core etc. Apparatus 2020 may comprise amplifier 2016 and power supply 2012. Power supply 2012 may include a DC power supply. Amplifier 2016 may be connected in closed loop to object 11 to create oscillations in object 11. Amplifier 2016 may include a solid state power amplifier. Optionally, isolator 2026 may be connected between amplifier 2016 and object 11. Apparatus 2020 may be configured to support oscillation conditions. In order to support oscillation conditions, the product of the amplifier gain [G] and the attenuation [A] in the load (object) must be approximately equal to one, e.g., G*A≈1. The object may be connected to the electrical circuit via two radiating elements 2028 such that feedback may be detected from the object and may be fed into amplifier 2016. Radiating elements 2028 may be embedded in object 11, including for example, a filter (e.g., SiC filter) or a converter core. The distance between the two radiating elements may be determined based on EM calculations and/or the need to support the oscillation conditions and/or based on other conditions for example, the material of the filter and/or the temperature of the filter. Radiating element 2028 may have a structure of a longitudinal electrode as illustrated in FIG. 4B, wherein the length of each electrode in a function of λ/4. The longitudinal radiating elements are discussed here by way of example only, with no intention to narrow the invention to any particular structure of radiating elements. Apparatus 2020 may be designed to generate EM oscillating waves in object by adjusting the amplifier gain [G] in accordance with a detected attenuation [A] of the supplied oscillating wave to the object. The attenuation [A] may be detected by radiating elements 2028 and then fed into amplifier 2016.

Some exemplary embodiments of a device for regenerating a filter, by creating EM oscillation in the filter or in an object in the filter (e.g., gases or soot) is illustrated in FIG. 4C, in accordance with some embodiments of the invention. Device 2100 comprises circuitry 2050. Circuitry 2050 may have a closed feedback loop (e.g., a positive feedback loop) using amplifier 2016, isolator 2026 and filter 2060. Filter 2060 may include any suitable filter, for example a DPF. Amplifier 2016 may be powered by power source 2012. For example, power source 2012 may include a 12V power source. Two radiating elements 2018 may be embedded in the filter having the necessary length to support the oscillation conditions. For example, the length of the radiating element(s) may be in the order of the wavelength (lambda) of the applied EM energy, e.g., lambda/4. Two metal grounded plates 2070 may be installed in the peripheral area of filter 2060 to form an oscillator (e.g., a resonator cavity). Experimental results, using circuitry with a single amplifier, comprised applying 60 W for 5 min showed elevation of a temperature in a filter by 80° C.

Referring back to FIG. 4A, in some embodiments, apparatus 100 may include a frequency modulator (not illustrated). The frequency modulator may include a semiconductor oscillator configured to generate an AC waveform oscillating at a predetermined frequency. The predetermined frequency may be in association with an input voltage, current, and/or other signal (e.g., analog or digital signals). For example, a voltage controlled oscillator may be configured to generate waveforms at frequencies proportional to the input voltage.

Processor 2030 may be configured to regulate an oscillator (not illustrated) to sequentially generate AC waveforms oscillating at various frequencies within one or more predetermined frequency bands. In some embodiments, a predetermined frequency band may include a working frequency band, and the processor may be configured to cause the transmission of energy at frequencies within a sub-portion of the working frequency band. A working frequency band may be a collection of frequencies selected because, in the aggregate, they achieve a desired goal, and there is diminished need to use other frequencies in the band if that sub-portion achieves the goal. Once a working frequency band (or subset or sub-portion thereof) is identified, the processor may sequentially apply power at each frequency in the working frequency band (or subset or sub-portion thereof). This sequential process may be referred to as “frequency sweeping.” In some embodiments, each frequency may be associated with a feeding scheme (e.g., a particular selection of MSEs). In some embodiments, based on the feedback (e.g., EM feedback) provided by detector 2040, processor 2030 may be configured to select one or more frequencies from a frequency band, and regulate an oscillator to sequentially generate AC waveforms at these selected frequencies.

Alternatively or additionally, processor 2030 may be further configured to regulate amplifier 2016 to adjust amounts of energy applied via radiating elements 2018, based on a feedback, e.g., detector 2040 may detect an amount of energy reflected from the energy application zone and/or energy coupled (to other radiating element) at a particular frequency.

In some embodiments, the apparatus may include more than one EM energy generating component. For example, more than one oscillator may be used for generating AC waveforms of differing frequencies. The separately generated AC waveforms may be amplified by one or more amplifiers. Accordingly, at any given time, radiating elements 2018 may be caused to simultaneously transmit EM waves at, for example, two differing frequencies to cavity 10.

In some embodiments, apparatus 100 may include a phase modulator (not illustrated) that may be controlled to perform a predetermined sequence of time delays on an AC waveform, such that the phase of the AC waveform is increased by a number of degrees (e.g., 10 degrees) for each of a series of time periods. In some embodiments, processor 2030 may dynamically and/or adaptively regulate modulation based on feedback from the energy application zone 9. For example, processor 2030 may be configured to receive an analog or digital feedback signal from detector 2040, indicating an amount of EM energy received from cavity 10, and processor 2030 may dynamically determine a time delay at the phase modulator for the next time period based on the received feedback signal.

Processor 2030 may be configured to regulate the phase modulator in order to alter a phase difference between two EM waves emitted to the energy application zone 9. In some embodiments, the source of EM energy may be configured to supply EM energy in a plurality of phases, and the processor may be configured to cause the application of energy at a subset of the plurality of phases. By way of example, the phase modulator may include a phase shifter. The phase shifter may be configured to cause a time delay in the AC waveform in a controllable manner within cavity 10, delaying the phase of an AC waveform anywhere from between 0-360 degrees.

In some embodiments, a splitter (not illustrated) may be provided in apparatus 100 to split an AC signal, for example generated by an oscillator, into two AC signals (e.g., split signals). Processor 2030 may be configured to regulate the phase shifter to sequentially cause various time delays such that the phase difference between two split signals may vary over time. This sequential process may be referred to as “phase sweeping.” Similar to the frequency sweeping described above, phase sweeping may involve a working subset of phases selected to achieve a desired energy application goal.

The processor may be configured to regulate an amplitude modulator in order to alter an amplitude of at least one EM wave supplied to the energy application zone 9. In some embodiments, the source of EM energy may be configured to supply EM energy in a plurality of amplitudes, and the processor may be configured to cause the application of energy at a subset of the plurality of amplitudes. In some embodiments, the source may be configured to apply EM energy through a plurality of radiating elements, and the processor may be configured to supply energy with differing amplitudes simultaneously to at least two radiating elements.

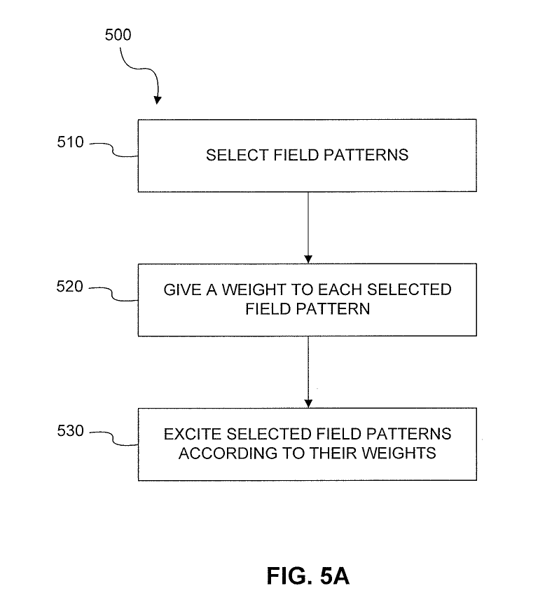

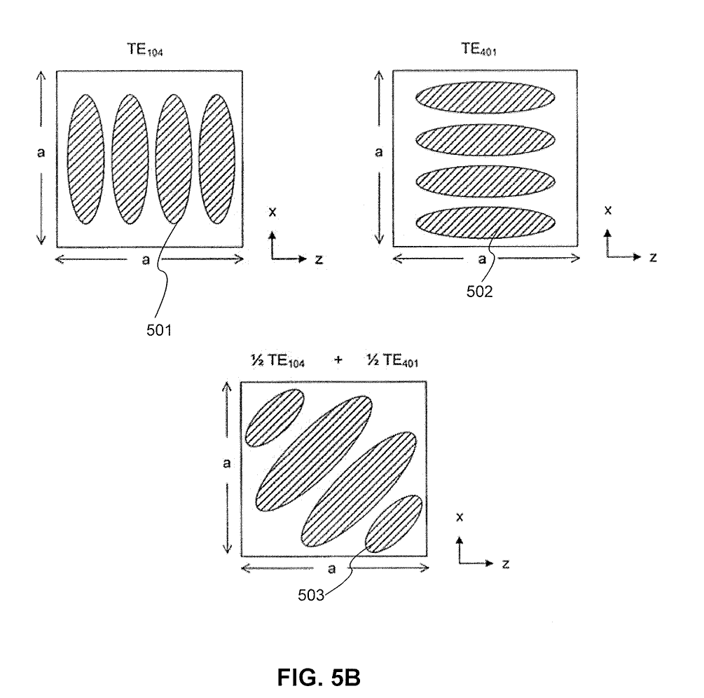

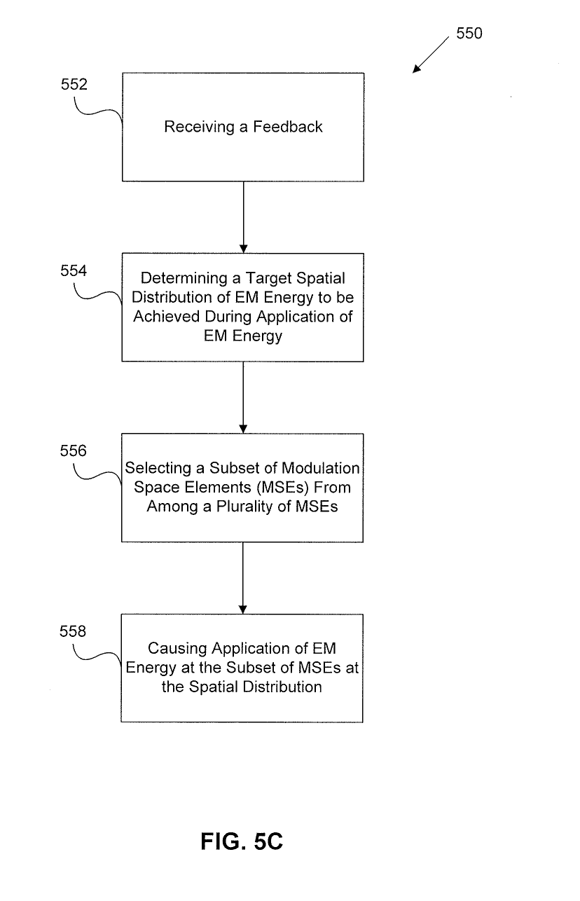

FIG. 5A is a flowchart of an exemplary method 500 of applying a spatial EM energy distribution to energy application zone 9, by exciting a target EM field intensity distribution in the energy application zone. In some embodiments, exciting a target EM energy distribution may be achieved by determining weights associated with field patterns. As shown in FIG. 5A, method 500 may include selecting one or more field patterns, as indicated in step 510. The selection may be based on a target EM field intensity distribution. The selection may be from multiple EM field patterns available to the apparatus (e.g., apparatus 100). The EM field patterns may be predetermined or may be determined based on a feedback from zone 9 (e.g., an EM feedback). Additionally or alternatively, the EM field patterns may include at least two linearly independent field patterns. Optionally, the EM field patterns may also include linear combinations of two or more modes. In some embodiments, step 510 is carried out by a processor (e.g., processor 92 or 2030). For example, the processor may cause application of energy at two MSEs that may result in the excitation of two field patterns 501 and 502, illustrated in FIG. 5B. Patterns 501 and 502 both related to the same mode family TE104 and TE401 are given in a way of example only. Method 500 is not limited to the excitation of any field pattern that may be excited in a particular EM energy application apparatus.

Method 500 may also include a step of weighting the selected field patterns (step 520). The weighting may be such that the sum of the field intensity distributions of the weighted field patterns equals to the target field intensity distribution, for example, to apply a first amount of energy to a first region in the energy application zone and a second amount of energy to a second region in the energy application zone 9. The first and/or second amounts may be predetermined or may be determined based on a received feedback (e.g., an EM feedback). In some embodiments, the first amount of energy may be different from the second amount of energy. The weighting may include the power at which the field pattern is excited and/or the time duration in which the field pattern is excited. For example, an equal weight of 0.5 may be given to field patterns 501 and 502.

Method 500 may also include a step of exciting the one or more selected field patterns. This excitation may be according to their weights, at step 530. The process may include, optionally, as part of excitation step 510, selecting one or more radiating elements for exciting each of the selected field intensity distributions. The selection may be based on the position of the selected (or not selected) radiating element, and in some embodiments also on the relationship between this position and the field value of the field pattern at the aforementioned position. For example when given an equal weight of 0.5 to field patterns 501 and 502, pattern 503 may be excited in the energy application zone 9.

FIG. 5C is a flowchart of another method 550 of controlling aspects of EM energy application to object 11 by apparatus 100, based on feedback. Method 550 may be performed, for example, by apparatus 100 shown in FIG. 1 or FIG. 4A, for example. Steps described in FIG. 5C belonging to method 550 may be performed by or in conjunction with processor 92 and/or a processor 2030 shown in FIG. 4A, for example. In some embodiments, method 550 may be used for applying EM energy in order to reduce the pollution emissions of a device (pollution reduction device), in order to heat soot in a filter (e.g., DPF) or in order to regenerate a filter optionally during the operation of the vehicle.

As shown in FIG. 5, in some embodiments, method 550 may first include receiving feedback (step 552). Feedback received in step 552 may include any type of feedback discussed herein, including but not limited to EM feedback, for example. At step 552, any number of analytical processes may be performed on the feedback. For example, the feedback may be subject to various filters, mathematical operations and/or logical operations in order to extract useful data, including, but not limited to, examples described herein. Alternatively, the feedback may be used without processing. In some embodiments, step 552 may be conducted in similar manner to step 304 of FIG. 3, as described above.

In some embodiments, at step 554, a spatial distribution of EM energy to be achieved during application of EM energy may be determined.

In some embodiments, the spatial distribution may be determined without feedback received in step 552. For example, the spatial distribution may be determined based on known characteristics of the energy application zone 9, object 11 or other entity in the vicinity of energy application zone 9. Such known characteristics may include, for example, a dimension or property of the energy application zone 9 or object 11. For example, the object 11 may include a filter or other device (e.g., a DPF) to be cleaned by application of EM energy and the known characteristics may include one or more dimensions of the filter or other device. The known characteristics may alternatively or additionally include a known EM energy absorption profile of the object 11 or energy application zone 9 or any other known characteristic that may be relevant to a determination of the spatial distribution. In addition or in alternative to the above, the spatial distribution may be determined based on one or more optional stored spatial distributions. For example, the processor 92 may determine a spatial distribution to use from a plurality of stored or predetermined spatial distributions. The determination of which spatial distribution to use may be based on, for example, an operation parameter of a system, device or object 11 (e.g., a filter, catalytic converter, DPF and/or a vehicle comprising the filter, catalytic converter or DPF) in the energy application zone 9. The operation parameter may include, for example, an operation condition of an engine associated with a vehicle.

In some embodiments, this spatial distribution may be based on the feedback received in step 552. Determining the spatial distribution based on feedback in step 552 may include using any of the examples of known characteristics of the energy application zone 9, object 11 or other entity in the vicinity of energy application zone 9 described herein in conjunction with the feedback. For example, feedback relating to temperature of the object 11 may be used to select from among a plurality of stored spatial distributions. As another example, feedback including a temperature or loss profile of the object 11 may be used in conjunction with a known dimension or layout of the object 11 (e.g., a layout showing a location of a filter or DPF to be heated within the object 11) to determine the spatial distribution. Any number of suitable protocols for determining the spatial distribution, including those based on the received feedback may be used, including, but not limited to, examples described herein. For example, the feedback may include a temperature or loss profile (as described above) of object 11. At step 554, the processor may, in this case, determine the spatial distribution such that portions of object 11 that have relatively low temperature, as indicated in the temperature profile, receive a relatively high level of EM energy in order to heat them. In another example, the processor may determine the spatial distribution such that portions of object 11 exhibiting relatively high loss, as indicated in the loss profile, receive a relatively high level of EM energy. It is to be understood that any suitable criterion and protocol discussed herein for applying EM energy may be used in step 554 to determine the spatial distribution in step 554.

In some embodiments, method 550 may also include a step of selecting a subset of MSEs at which EM energy is to be applied to the energy application zone. The subset of MSEs may be selected based on known characteristics of apparatus 100, for example the usable bandwidth of MSEs, or know characteristics of object 11, for example frequencies which are resonant in object 11. In some embodiments, selecting two or more subsets of MSEs from a predetermined subset of MSEs may be conducted in a predetermined order (e.g., sequentially), for example a first subset of MSEs may be selected to be applied and a period of time later a second subset of MSEs may be selected to be applied. Additionally or alternatively, the selecting may be based on a feedback, for example selecting a subset of MSEs all associated with EM feedback value at each MSE higher (or lower) than a threshold. In some embodiments, the subset of MSEs may be selected to provide the target spatial distribution (step 556). The subset of MSEs may be selected from a plurality of MSEs available to apparatus 100 or that apparatus 100 is otherwise capable of providing. The plurality of MSEs may be predetermined and stored in a memory to which controller 101 (or processor 92 or 2030) has access. Alternatively, the plurality of MSEs may be determined during any of steps 552-556.

Energy may be applied to the subset of MSEs (simultaneously, sequentially, or in any desired order or groupings) such that field patterns are generated corresponding to each of the subset of MSEs for which energy is applied. A linear combination of the resulting field patterns and the energy applied via those field patterns may provide the target spatial distribution of EM energy, as discussed above. The subset may include any suitable number of MSEs for creating the patterns for providing the target spatial distribution of EM energy. In some cases, the subset may include only a single MSE. In other embodiments, the subset may include two, three, or many MSEs.

The target spatial distribution may enable energy application to selected regions of energy application zone 9 or in or on object 11. For example, the target spatial distribution may apply a first amount of energy to a first region in the energy application zone 9 and a second amount of energy to a second region in the energy application zone 9, the first and second regions corresponding to different portions of the object 11. In some embodiments, the first amount of energy may be different from the second amount of energy in order to, for example, heat different portions of the object 11 to different temperatures.

Method 550 may also include a step of causing application of EM energy at the selected subset of MSEs, optionally in order to provide the spatial distribution (step 558). Step 558 may further include determining a time duration and/or power levels for applying the EM radiation. Determining a time duration may be based on, for example, the feedback received in step 552. For example, the time duration may be set, based on the feedback, such that a certain portion of object 11 is heated to a certain temperature. Alternatively, the time duration may be based on other considerations, such as a user set time duration, for example. The application may include, optionally, selecting one or more radiating elements for exciting each of the MSEs in the subset. The selection may be based on the position of the selected (or not selected) radiating element, and in some embodiments also on the relationship between this position and a field value of the MSE at the aforementioned position.

It is to be understood that, although FIG. 5C shows a single iteration of method 550, the method may be performed any suitable number of iterations. For example, method 550 may be performed in an iterative fashion in order to update the application of EM energy (step 558) according for example to changes in feedback received in step 552. In some embodiments, method 550 may be iteratively performed according to a criterion with respect to the feedback. For example, method 550 may be performed until a certain portion of object 11 is heated to a certain temperature. Additionally or alternatively, method 550 may be iteratively performed for a fixed or set number of iterations or for a fixed time period.

When method 550 is performed iteratively, a timing of the iterations may also be set and/or changed. The timing of the iterations may be set and/or changed in any of steps 552-558. The timing of the iterations may be set according to a particular goal with respect to EM energy application. The goal may or may not be defined in terms of the feedback collected in step 552. For example, the timing of the iterations may be set such that iterative applications of EM energy in step 558 are performed with sufficient rate to maintain a portion of object 11 at a particular temperature, as measured by a feedback temperature profile received in step 552. Alternatively, or in addition, the timing of iterations may be set such that iterative applications of EM energy in step 558 do not exceed a threshold associated with a known materials parameters of the object 11. For example, the timing may be set such that successive iterations do not reach an EM energy/power threshold above which portions of the object 11 may lose structural integrity.

Some or all of the forgoing functions and control schemes, as well as additional functions and control schemes, may be carried out, by way of example, using structures such as the EM energy apparatus schematically depicted in FIG. 1 or FIG. 4A. Within the scope of the invention, alternative structures might be used for accomplishing the functions described herein, as would be understood by a person of ordinary skill in the art, reading this disclosure.

In some embodiments EM energy may be applied to a converter, or a filter in order to reduce the pollution emissions in exhaust gas(es) and/or to increase the efficiency of conversion of compounds and/or soot in the exhaust gas(es) (e.g., conversion of potentially hazardous compounds into substantially less harmful gases or components, etc.). The soot and or other compounds, may comprise a plurality of particles, thus may be regarded as a particulate matter. Some examples of such hazardous compounds include: carbon monoxide (CO), nitrogen-oxides (NOx, such as NO and NO2) and unburned hydrocarbons (HC), for example: soot. The converter may be a catalytic converter having catalyst (e.g., catalytic particles such as Pd, Pt, Pt-Rd, K2O and/or MoCo) spread on a core. The core may have, for example, a honeycomb shape, or any other suitable shape. The core may be made from, for example, stainless steel foil or ceramics, for instance, silicates and/or aluminates. The surface of the converter may be designed to have an increased or large surface area, to support larger amount of catalytic particles and to increase the total area of the conversion reaction sites.

In some embodiments, EM energy application to a catalytic converter may result in an increased rate of a chemical reaction that takes place on the surface of the catalyst; and thus may allow the use of smaller amounts of catalyst (in comparison to a commercial converter) in order to reduce the hazardous gas compounds in the exhaust gas(es). For example, a desired spatial profile (spatial distribution) of the EM energy application may be applied (according to method 550, for example) such that different areas within the converter may reach different temperatures that will favor different chemical reactions. In some areas inside the converter, the temperature may reach the decomposition temperature of NOx; and in other areas the temperature may reach the formation temperature of N2 and O2. In some embodiments, the EM energy application may eliminate the need of added catalyst (e.g., catalytic particle of: Pd, Pt, Pt-Rd, K2O and/or MoCo), by, for example, elevating the temperature of a ceramic porous core to a temperature where the chemical reaction may take place on a surface of the core. For example, the EM energy application may increase the temperature to above 500° C., 700° C., 800° C., or 900° C. at least in a portion of the converter. In some embodiments, the EM energy may be applied to oxidize toxic CO and HC into CO2 and water.

In some embodiments, EM energy may be applied to a filter (e.g., for DPF regeneration) to burn the particles that precipitate on the surface of the filter (trapped in the filter), e.g., soot particles. In other filtering systems other types of particles, referred to herein as precipitate particles, may precipitate on the filter surface, and an oxidation process (e.g., combustion or burning) may be required to regenerate the filter. The description referring to regeneration as relating to the burning of soot particles from exhaust gases, for example, should not be limited to this particular embodiment and may be applied to any filtering system that needs to be regenerated or cleaned (e.g., by cleaning the filter or by reducing the amount of particles precipitated on the filter). Other embodiments of filtering systems to which periodic regeneration or cleaning, according to aspects of the invention, may also be applied include air-conditioning systems or any filtering system that collects particles (or particulates) on a filter.

In some embodiments, EM energy may be applied to the exhaust gases flowing through an apparatus designed to burn soot particles on the fly. Optionally, no filter or other mechanical means may be used to trap the soot particles. In this filter-less apparatus, soot particles may be burned electromagnetically in a device designed to apply a sufficient amount of energy for burning the particles (e.g., by elevating the temperature of the soot particles sufficiently to induce at least some oxidation and/or combustion of the soot particles). One exemplary method to effectively apply EM energy is by generating a plasma inside the device (e.g., by applying high power EM energy). Soot particles that flow through the plasmoid (the discharge area) may oxidize and burn.

The EM energy may oxidize the precipitated particles, for example, in the presence of air. This oxidizing of the soot may achieve substantially complete burning of the HC in the precipitated particles resulting in other compounds (e.g., CO2 and water). The oxidation reaction may take place on a surface of the filter or inside a plasmoid. Alternatively or additionally, the oxidation reaction may occur on the surface of catalytic particles added to the filter. The EM energy may be applied to the filter, such as, for example, to locations where soot may precipitate or is determined/known to precipitate, in order to heat specific locations of the filter (e.g., according to method 550 wherein the spatial distribution corresponds to the specific locations of the filter). Detecting an EM energy loss (also referred to herein as a “loss profile”), or different values indicative of EM energy absorption from different locations in the filter or any other feedback may indicate locations with higher amounts of soot precipitation. The processor (e.g., processor 92 or 2030) may adjust the EM energy application to heat the soot precipitation locations detected this way or detected in other ways.

In some embodiments, EM energy may be applied to a semi-continuous DPF filter. A semi-continuous DPF filter may be a filter divided to at least two parts which are separated by at least one partition. The partition may be configured to block the gas flow from one part to the other. In some embodiments, the partition(s) may be made from or may comprise conductive material thus creating a resonator cavity in each part of the semi-continuous DPF filter. Partitions(s) made from conductive material may be used to obtain an electrical partition between different parts of the semi-continuous DPF, thus controlling the application of EM energy to a specific part. In other embodiments, the partition(s) may be fully or partially non-conductive, and EM energy distribution in the semi-continuous DPF may be controlled such that EM energy may be applied to a particular part of the semi-continuous DPF. Each partition may be temporarily substantially sealed (to block the gas flow from the exhaust). During the temporary sealing (blocking) of a particular part, the EM energy may be applied to the particular (blocked) part (e.g., by first determining the location of the blockage using various methods and then determining a spatial distribution of EM radiation to heat the blockage, such as via method 550) to burn the soot trapped in this particular part. Gas flow may reduce the temperature of the filter thus may require the application of higher EM energy to burn the soot particles. Temporary blocking the gas flow to one part in the filter may allow burning the soot using lower EM energy. Blocking only one or more part(s), but not all of the parts of the soot filter, may allow the gasses to flow uninterruptedly through the rest of the filter (e.g., through the part(s) which are not blocked) and may allow the soot particles to be trapped in the filter (e.g., in the part(s) which are not blocked). Upon burning the soot in the first blocked part, the temporary blocking or sealing may be shifted to a second part and the EM energy may be applied to the second part in order to burn the soot trapped in the second part. The shifting from one part to another may occur at time intervals, and the temporary blocking and burning may take on a duration, for example shifting every 3 min blocking and burning for 1 s. In some embodiments, the partitions may not have physical boundaries and may be considered as constituting different regions or locations within the DPF filter, to which EM energy may be applied.

The discussion below addresses the application of EM energy to various devices and in various contexts using one or more of the methods 300, 500, 550, or other method discussed herein. Although one or more methods may be explicitly mentioned in the context of a particular application, it is to be understood that such discussion is not limiting. More specifically, it is to be understood that any method discussed herein may be applied to any particular application discussed herein, regardless of whether or not the method is explicitly mentioned in the discussion of the application below.

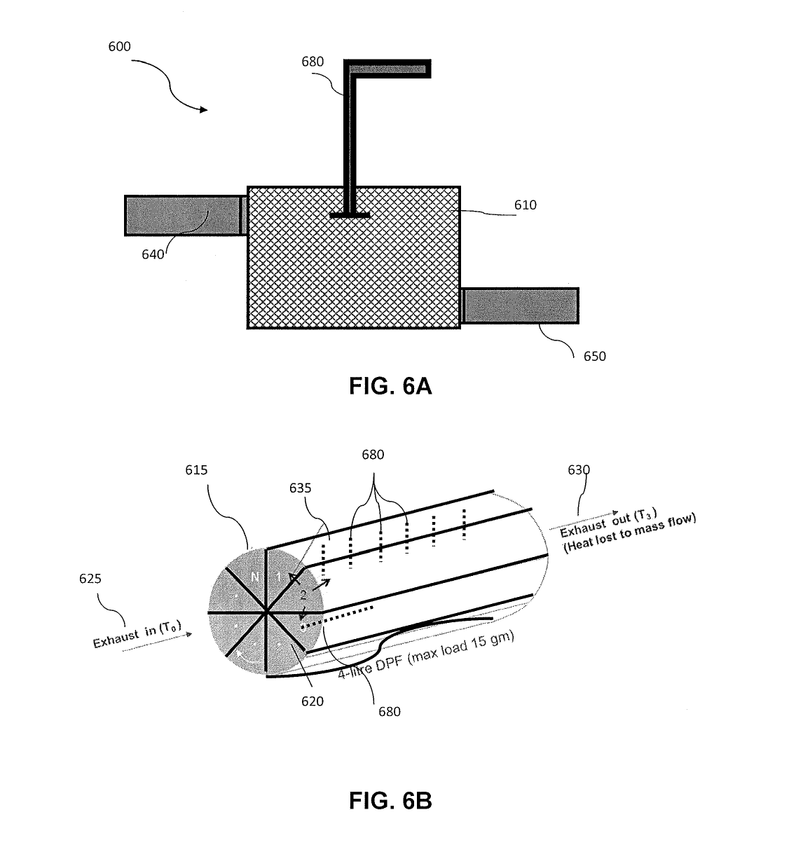

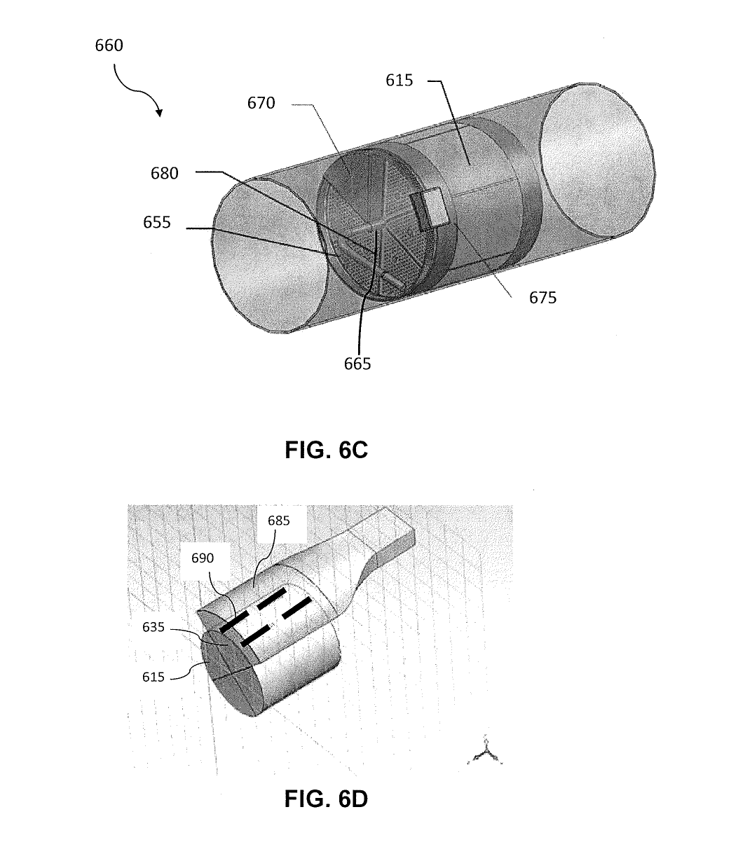

Reference is now made to FIG. 6A illustrating a pollution emission reduction device 600. Device 600 may include a filter (e.g., soot filter), or a catalytic converter. Device 600 may comprise a porous filtering element or a core 610, both may be regarded as target material. Additionally or alternatively, the precipitated particles on the filtering element (e.g., soot) may be regarded as target material. The porous filtering element may have a honeycomb shape or another porous shape. The filtering element may be made from ceramic material such as metallic oxides (e.g., alumina, low iron cordierite, aluminosilicates or silica) for example, having low loss tangent (low EM losses) or carbides (e.g., SiC) having medium loss tangent or metals. Carbides such as SiC are medium EM absorbers especially in the RF range and may initiate a chain combustion process. In some embodiments, a coating material may be used to coat to the filtering element. Coating the filtering element with a coating, for example, TiO2, BaTiO4, oxides and mixtures thereof, with a thickness of several microns may provide a thin layer of high dielectric material that may absorb EM energy and heat. The coating may also be used to tune pore size. Device 600 may also include entrance 640 and exit 650. Entrance 640 may be in fluid communication with an exhaust gas. For example, entrance 640 may include a pipeline connecting the exhaust gas stream with device 600.

Device 600 may further include at least one radiating element 680. Radiating element 680 may be embedded in the filtering element or the converter core. Optionally, the radiating elements 680 may be installed in proximity to the filter or the core or. In some embodiments, a plurality of radiating elements 680 may be embedded in the filtering element or the core. In some embodiments, the filter may be made of or comprised of a conductive material and may function as the radiating element.

In some embodiments, device 600 may be assembled in vehicles powered by an internal combustion engine, (e.g., such vehicles may include diesel or gasoline powered passenger cars, buses, trucks, motorcycles, etc). Device 600 may be included in any system powered by combustion engines where a reduction in or regulation of pollution emission may be desired. Pollution emission reduction device 600 may also be included in systems where reduction of pollution emissions may be required, including, for example, in air filtering systems.

Reference is now made to FIG. 6B illustrating filter 615, in accordance with some embodiments of the invention. Filter 615 may include, for example, a DPF soot filter, or convertor core. Filter 615 may be part of device 600. Filter 615 may be divided into N parts by partition(s). Filter 615 may also be referred to herein as a semi-continuous DPF filter. Filter 615 may optionally include physical partitions 620 designed to block or substantially block gas(es) flow from one part of the filter to another. Partitions 620 may be constructed from a material transparent to EM energy, in particular in the RF range, or may be comprised of material that is reflective of EM energy (e.g., conductive material). An example for a partition reflective to EM energy is a metallic partition or a partition comprising a metallic net or grill embedded in a polymer wherein the distances between the grill or the net lines is a function of the wavelength of the applied EM energy, e.g., less than λ/4. In some embodiments, a partition reflective to EM energy may create a resonator cavity (e.g., in part 635) of filter 615. Filter 615 may have any suitable shape including but not limited to: a cube, a prism, a cylinder, a ball etc. Filter 615 may be constructed from several filters, for example several cylindrical filters grouped together, or several prisms grouped together. Filter 615 may have any shape and/or structure configured to filter, convert and/or burn pollution emissions (e.g., soot particles). The emissions (e.g., exhaust gases) may enter (flow) from entrance 625 and may exit (flow) from exit 630. In some embodiments, filter 615 may not be physically divided by partitions 620. Thus, EM energy may be applied to achieve a spatial distribution determined with respect to different parts, regions or locations in filter 615 (e.g., using method 550 of FIG. 5C).

EM energy, for example in the RF range (may be referred to as RF energy), may be applied to part 635, thus heating part 635, while avoiding heating the other parts of the filter. For example, a first spatial EM energy distribution may be determined and then applied to a first portion of the device (e.g., part 635), in order to heat a target material associated with the first portion of the device, for example to burn soot particles trapped in part 635. A second spatial EM energy distribution may be determined, for example to burn soot particles trapped in another part of filter 615. After a time interval subsequent to the application of EM energy at the first spatial distribution of EM energy, EM energy may be applied, such that the second spatial distribution of EM energy is applied to the target material associated with the second portion of the device (e.g., the soot trapped in another part 635). Additionally or alternatively, RF energy may be applied sequentially to one or more portions of the device (e.g., parts 635 (e.g., to all parts) of filter 615). In some embodiments, one or more radiating element(s) may be provided in each part of the filter. EM energy may be applied to part 635 by supplying EM energy to radiating element 680 embedded in or located in proximity to part 635 (for example, to a near field element attached to the outer face of part 635, as illustrated for example in FIG. 6C).

In another example, an array of radiating elements 680 (dashed lines in FIG. 6B) may be embedded in filter 615 from a face (e.g., an outer peripheral face) of each part, and may be configured to apply energy to the volume of the part. In some embodiments, a length of radiating element(s) may be a function of the wavelength (λ) of the applied EM energy, e.g., 212. In some embodiments, a phase difference may be set between at least two radiating elements 680. A subset of MSEs may be selected from a plurality of MSEs to include various phase differences (e.g., 0, 45 degrees, 90 degrees, 135 degrees etc.) between at least two radiating elements 680, to cause a (spatial) shift in an intensity maxima of an EM field excited in the filter (e.g., the intensity maxima of a first phase differences configuration may differ from the intensity maxima of a second phase differences configuration). A location (within the filter) of intensity maxima associated with a first phase differences configuration may differ from a location the intensity maxima of a second phase differences configuration. Controlling the shifting may cause application of RF energy to different portions (e.g., parts, partitions, regions) of the filter. Such shifting is an example of one of the ways MSEs can be selected to product a spatial distribution (e.g., using method 550).

In some embodiments, controlling the EM energy application to more than two parts (portions) may be done using at least two radiating elements. Radiating elements 680 are illustrated in FIG. 6B as being installed in the same partition, however, each radiating element may be included in a different partition. In some embodiments, a processor (e.g., processor 92 or processor 2030) may be configured to select a first subset of MSEs, for example by selecting at least one radiating element embedded in a first portion of the filter (e.g., part 635), optionally in order to apply EM energy to the first portion. The processor may further be configured to select a second subset of MSEs, for example by selecting at least one radiating element embedded in a second portion of the filter, optionally in order to apply EM energy to the second portion. The processor may further be configured to cause application of EM energy at the first and/or second sets, optionally to apply EM energy to the first and/or second portions of the filter. Selecting one or more radiating elements from a plurality of radiating elements in order to apply EM energy to different portions and locations in a filter is another example of one of the ways MSEs can be selected to provide a spatial distribution (e.g., using method 550).

In some embodiments, radiating element(s) 680 may be connected to a power source (not illustrated) by any suitable means. In other embodiments, radiating elements may not be connected to a power source and the EM energy may be coupled to radiating element(s) from a radiating element not provided in filter 615 but in close proximity to filter 615. Additionally or alternatively, one or another radiating element 680 may be embedded in one or more part(s) of filter 615, from the gas entrance side 625. This embodiment is discussed broadly with respect to FIG. 6D. Additionally or alternatively, one or more radiating element(s) 680 may be embedded in one or more part(s) of filter 615, from the gas exit side 630 (not illustrated).

Any configuration of radiating elements may be installed in one or more parts of filter 615, and the configurations of the elements installed in each part may be similar or different. In some embodiments, only some, but not all, of the parts in filter 615 may comprise radiating elements. In some embodiments, a spatial EM energy distribution may be applied to filter 615 to selectively heat one or more part(s) 635 according to some embodiments, for example according to method 550. In some embodiments, partition(s) 620 may be constructed from a material transparent to EM energy which contains no partitions and the spatial distribution of the EM energy application may be controlled such that EM energy may be applied to heat one or more particular part(s) 635 while avoiding heating other parts. EM energy may be controlled by selecting one or more MSEs to be excited in filter 615, for example in accordance with methods 300, 500 or 450. In some embodiments, this may be facilitated by controlling a phase of the signal applied to the radiating element(s) in each part, e.g., by controlling a phase difference of the EM signal supplied to two or more radiating elements.

Semi-continuous pollution emission reduction device 660 is illustrated in FIG. 6C, in accordance with some embodiments of the invention. Device 660 may be designed to burn soot trapped in filter, such as filter 615, during the operation of a vehicle. Device 660 may be designed to block exhaust gases from entering at least one selected part of filter 615 while applying EM energy to the selected part. The other parts may be opened for gas flow and act as mechanical filters. Device 660 may be connected to a processor, e.g. processor 92 or 2030, configured to block and apply EM energy to different parts of the filter to efficiently regenerate the filter during the operation of the vehicle. Device 660 may comprise filter 615 which may be divided to N parts by partitions (where N is a number higher than 1), as discussed above with respect to FIG. 6B. N radiating elements 680 may be each embedded in different parts (e.g., parts 635) of filter 615. Optionally, two or more radiating element may be embedded in each part from each side of the filter (e.g., two elements may be embedded in or near gas entrance side 625 and from gas exit side 630). Additionally or alternatively, an array of radiating elements may be embedded in the peripheral or other side of each filter part (as illustrated for example in FIG. 6B). Radiating elements 680 may have a finger shape, as illustrated in FIG. 6C, or may have any other structure designed to apply EM energy. Device 660 may further include coaxial cable 655, for example for feeding (supplying) RF or MW energy to one or more radiating element(s). Coaxial cable 655 may be connected to a an EM source (e.g., a power supply) and a processor (not illustrated) according to some embodiments of the invention.

Coaxial cable 655 may be connected to rotary joint 665, for example. Rotary joint 665 may be designed to transfer EM energy, for example RF energy, to moving and rotating parts. Rotary joint 665 may be connected to rotating coupler 670, designed to couple EM energy from coaxial cable 655 to radiating element 680. Rotating coupler may be made or comprise conductive material thus enabling coupling of the EM energy. Rotating coupler 670 may be rotated by motor 675. Motor 675 may be controlled by a processor to shift (rotate) rotating coupler 670 from one radiating element to the other. In some embodiments, rotating coupler 670 may be mechanically connected to radiating element(s) provided in part 635 when rotating coupler 670 is placed (covers) that part. Rotating coupler 670 may also be used to block the exhaust gases flow through the filter part treated by EM energy (e.g., part 635). Similar system comprising coaxial cable 655, rotary joint 665, rotating coupler 670, motor 675 and radiating elements 680 may be installed in the other side (exit side 630) of filter 615 as well.

Device 660 may be controlled, for example by a controller (e.g., controller 101 or processor 2030) (not illustrated), to periodically block the flow of exhaust gases in a selected part in filter 615 while burning the soot trapped in the selected part (e.g., by applying EM energy to the selected part). EM energy can be applied to the selected part by determining a suitable set of MSEs using, for example, method 550. Rotating coupler 670 may be shifted from one part to the other, coupled each time to the radiating element embedded in that part, and may block (or substantially block) the exhaust gases from entering that part while applying EM energy to burn the soot trapped in that part. Optionally, a parallel system may apply EM energy to the other end (exit side 630) of the selected (treated) part. The controller may synchronize the two systems to block the gases flow and apply the EM energy to the same part each time. The controller may be configured to sequentially block and burn the N different parts of filter 615 periodically, or select which part to block and apply EM energy. The periods or the selection of the parts may be determined, for example, according to a feedback (e.g., feedback indicative of pollution emissions or a value indicative of EM energy absorbable in the filter), determined according to some embodiments of the invention. Device 660 may further include a detector configured to measure (detect) and send the feedback (e.g., feedback indicative of pollution emissions to the controller). The feedback may be or include an EM feedback (EM signal), and EM energy may be applied according to the feedback using method 300 or 550, for example. The controller may further adjust the EM energy application to the device, the duration of the blocking and the timing of the shifting of rotating coupler 670 based on the received feedback.

In some embodiments, the radiating element may be a near field element or a slow wave antenna as illustrated for example in FIG. 6D, in accordance with some embodiments of the invention. Filter 615 having 4 parts (N=4) is used as an example for a divided filter. Radiating element 685 may be designed as a wave guide having one or more slot(s) 690 for emitting RF energy (e.g., near field energy) to part 635. EM waves may travel through element 685 and may be emitted from slot 690 to the filter. EM energy emitted from slot 690 may be coupled to filter part 635. Slot 690 may be located in any part of element 685 and may have any shape designed to emit EM energy. Element 685 may have a plurality of slots 690. The plurality of slots may be identical or have different shapes. In some embodiments, more than one element 685 may be provided in proximity to filter 615. Optionally, N radiating elements (e.g., 4) are provided in proximity to each part in the filter designed to apply EM energy to that part, such that filter 615 is entirely covered by radiating elements 685. Although the exemplary embodiment discussed herein involves the use of element 685 with a divided filter 685, it is to be understood that element 685 may be used with a filter including any number of divisions. Element 685 may also be used with a filter that has no divisions. In other embodiments, radiating element 685 may be shifted by mechanical means from one part of filter 615 to another. In some embodiments, the exhaust gases flow may be blocked or substantially blocked from a part that is subject to EM energy application (e.g., from radiating element 685). Optionally, mechanical blocking (e.g., by a rotary blocking element shifted by a motor) or EM blocking (e.g., shutters powered by electromagnets) systems may be installed to block the pollution emissions (e.g., exhaust gas flow) from entering a selected part. A controller may be configured to control the pollution emissions from entering a selected part and to apply EM energy to element 685 installed in proximity to the blocked part, using, for example, method 550.

In some embodiments, rotating coupler 670 or rotary blocking element may be comprised of an array of Microelectromechanical systems (e.g., MEMS shutters). In other embodiments, rotating coupler 670 or rotary blocking element may include a flap or a shutter that may be mechanically opened or closed thus blocking part 635 of filter 615. Shutter may be opened or closed around an axis.

In some embodiments, radiating elements 680 and/or 685 may be designed to generate plasma or to create plasmoid in the emission reduction device (e.g., device 600 or 660) in order to burn soot, e.g., by applying high power EM energy. Soot particles flowing through the plasmoid (the discharge area) may oxidize and burn.

In some embodiments, filters 610 and 615 may be combined with radiating element 680, such that the filter itself becomes the radiating element. Filter 610 or 615 may be comprised of a conductive structure configured to emit EM energy. For example, the filter may be constructed from a metallic material, such as various alloys, thus when coupled to wave guide or a coaxial cable (e.g., cable 655) may emit EM energy (EM waves) that may burn the soot trapped in the filter.

In some embodiments, radiating elements 680 and 685 may be designed to generate plasma or to create plasmoid in the emission reduction device (e.g., device 600 or 660). In some embodiments, soot particles may be burned while flowing through a periodic structure (1D, 2D or 3D periodic structure, for example a helix or a honeycomb) while being exposed to high EM fields (radiated from the periodic structure).

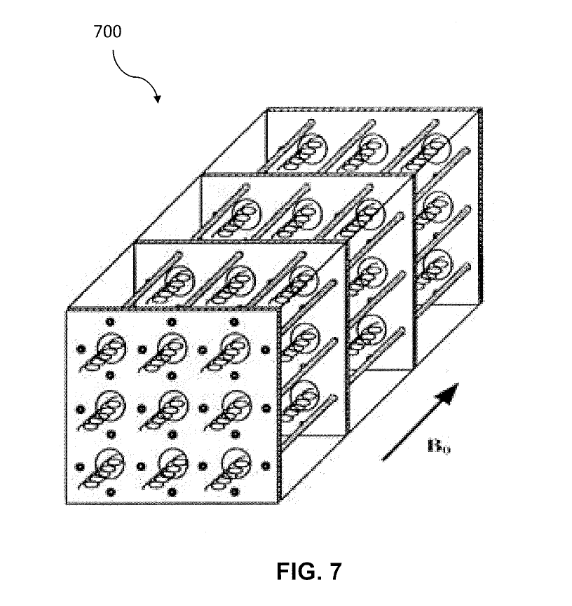

A periodic structure 700 is schematically illustrated in FIG. 7 in accordance with some embodiments of the invention. In some embodiments, near field or evanescent EM field may be emitted from the periodic structure. In some embodiments, filter 610 or filter 615 may omit a mechanical filter (e.g., a porous ceramic filter) and may be designed to burn particles (e.g., soot particles) on the fly (i.e., during uninterruptedly flow in a pipe or the filter). One advantage of such a filter may lay on the fact that little or no back pressure may be applied to the engine. The particles may be burned in a plasmoid generated by the radiating element(s). The plasmoid may be created by local discharges in the flowing gases exposed to an EM field excited in a pipe or a filter. The pipe may include or be connected to a pipe in which exhaust gas flow from the engine. In some embodiments, a periodic structure (for example a helix structure) may be provided in the pipe.

In pipes such as an open pipe, for example, it may be required to add a structure in the inner part of the pipe to position the plasmoid at a particular part in the pipe. The structure may be active (i.e. act as the radiating element) or passive (i.e. act as an EM field concentrating element). The gases flowing through the structure may have already been heated by an engine and, for similar reasons, may contain ions. The EM field may accelerate the electrons and may increase the ionization until plasma and local heating happens. In some embodiments, it may be beneficial not to slow a flow of the pollution emission gases (e.g., exhaust gases). An exemplary embodiment of a structure that may prevent or diminish retardation of the flow is a periodic structure from conductive material. The structure may be parasitic (not connected to the pipe (the cavity) or shorted (connected to the cavity). The periodic structure may, for example, have periodicity in one direction (e.g., a ladder or a helix), in two directions (e.g., a honeycomb structure) or in three directions (e.g., a lattice). The periodicity may be a function of a wave length (λ) of the waves emitted in the pipe or cavity. Other means may be used to position the plasmoid. For example two electrodes or two X like structures may be located in two parts along the pipe or the cavity located inside the pipe, such that the plasmoid is generated in between the two electrodes or the two X like structures. The invention in is broadest sense is not limited to any particular structure designed to position a plasmoid in a cavity.

In some embodiments, the application of EM energy may reduce the size and weight of the converter core. This may reduce or even eliminate the pressure drop in the converter. EM energy application to a catalytic converter may increase rates in comparison to those in conventional catalytic converters or converters to which EM energy is not applied. Higher rates may allow more efficient use of converter core surface area (e.g., may allow for similar conversion rates even when substantial amounts of the core surface is obstructed or otherwise non-functional). In some cases, this effect can be exploited so that a smaller ceramic converter core may be produced by a sol-gel method which may reduce the density of the core from 6 g/cm3 in conventional converters to less than 2 g/cm3 or less than 1 g/cm3 while at least maintaining the same or similar conversion efficiency.

A soot filtering element may include a porous material made, for example, from ceramic material or metal which may have a structure designed to trap or advantageous for trapping the soot particles. The ceramic material may be a metal oxide such as alumina or zirconia, for example, or carbide such as SiC. The filter may include catalytic particles or catalytic compounds to, among other things, accelerate the combustion of the soot (soot burning). The filter may be designed such that no significant reduction in exhaust gas(es) pressure may be detected between an entrance and an exit of the filter. EM energy may be applied to the filter when a certain amount (e.g., above a predefined threshold) of soot is trapped thus blocking part of the filter. Such an application of EM energy may help to avoid reduction in the exhaust gas(es) pressure (for example, to an extent that will reduce the vehicle velocity). In some embodiments, EM energy may be applied, using any of the methods described herein, to a filter after a relatively low amount of particulate matter, e.g. soot, is trapped in the device (e.g., a filter), for example less than: 500 mg, 1 g, 2 g, 4 g, 5 g, 10 g, or 25 g. In some embodiments, the initial timing of causing application of the EM energy at the first subset of MSEs or at the first spatial distribution may be based in part on an amount of trapped particles exceeding 25 g.

In some embodiments, EM energy may be applied to a device to heat target material, using any of the methods described herein (e.g., method 300, 500, or 550,), for example, to burn the precipitated particles, e.g. soot trapped in the filter, according to time intervals. For example a time interval between two consecutive EM energy application events may be: 1 min, 2 min, 3 min, 5 min, 10 min, 20 min, 30 min or 60 min. Such a time interval may correspond to a time interval between successive iterations of method 550, as described above, for example. The interval may depend on the driving regime (i.e., cold ignition, cruising or acceleration). Additionally, the EM energy may be applied for a duration. For example, each EM energy application event may take: 0.5 s, 1 s, 2 s, 5 s, 10 s or 30 s. For example, EM energy may be applied for 2 s every 5 min. In some embodiments, different time intervals and different time durations of EM energy application may be applied at various driving regimes. The EM energy application may be controlled based on feedbacks related to the different driving regimes.

For example, during cold start or at the beginning of a driving, e.g., when a feedback from a thermometer indicates that the filter is cold, thus engine produces relatively large amounts of soot, EM energy may be applied at short time intervals for longer durations (e.g., every 2 min for 5 s). During cruising (e.g., when a feedback from a speedometer indicates that both the engine and the filter are working in optimum conditions,) the time intervals may be longer (e.g., every 4 min) and the duration the EM is applied may be shorter (e.g., 2 s).

In some embodiments, the time intervals between two consecutive EM energy applications and the time duration of applying the EM energy may be controlled based on signals received (e.g., detected) from the engine, for example the velocity of the vehicle [in KMH], the angular velocity of the engine [in RPM], the torque, etc. In this case the signals received or detected may, for example, correspond to feedback, according to the definition applied in method 300 or 550. For example, in uphill driving (e.g., when climbing a mountain) when the angular velocity increases, the time intervals may be decreased and the duration for applying EM energy may be increased.

In some embodiments, feedback indicative of the pollution emissions may be received. In some embodiments, EM energy application may be controlled based on the feedback (e.g., according to method 300 or 550). The feedback may provide indication on an amount and/or temperature of the exhaust gases or the soot trapped in the filter, flow of the exhaust gases, back pressure, size of particles, chemical composition or concentration of compounds, presence of ions etc. An exemplary feedback may include the amount of precipitated particles trapped in the filter that may be determined by applying EM energy to the precipitated particles trapped in the filter. EM feedback (e.g., a value indicative of energy absorbable in the precipitated particles trapped in the filter) may be determined according to steps 302 and 304 in method 300, illustrated in FIG. 3 or according to any other known method. The EM feedback may be correlated to the amount of particles trapped in the filter, for example by a linear correlation wherein any increase in the amount of particles trapped in the filter may increase (e.g., linearly increase) the EM feedback. The correlation may also be other than linear. The correlation may be determined analytically, numerically and/or may be stored in a lookup table in the processor, e.g. processor 2030, or in a memory storing device associated with the processor.

In some embodiments, other signals may be used as feedback indicative of the pollutions emissions (e.g., in method 300 or 550, for example). For example, a temperature of the filters or the exhaust gases, the speed of the engine, the flow rate of the exhaust gases, the torque of the engine, the back pressure from the exhaust gases on the engine, the composition and concentration of the hazardous compounds in the exhaust gases, presence of ions in the gases and/or the particle size for example the soot particle size. A feedback indicative of pollution emissions may include any feedback that may indicate such values as: the characteristics of the pollution emissions, any parameters from the vehicle that may affect the pollution emissions, or the state of the emissions pollution reduction device. The feedback may be or include EM feedback (e.g., detected from radiating elements) or may include any other feedback (e.g., detected from one or more sensors provided in the device).

In some embodiments, the EM energy application may be dynamically controlled (or adjusted) based on a feedback, for example: feedback indicative of pollution emissions, (e.g., according to method 300). The processor (e.g., processor 92 or 2030) may be configured to monitor the changing conditions, by receiving at least one feedback indicative of pollution emissions from one or more of the pollution emission reduction devices installed in the vehicle (e.g., DPF, converter of catalytic converter). The processor (e.g., processor 2030 or 92) may be further configured to adjust the EM energy application to each device according to the feedback indicative of pollution emissions. For example, processor 92 may receive a feedback regarding the amount of soot trapped in a particular part in a filter (e.g., filter 610 or 615) and may cause the application of EM energy to radiating element(s) 680 or 685 in order to burn the soot in that part. Additionally, processor 92 may cause motor 675 to rotate rotating coupler 670 to block that part to exhaust gas flow.

The amount of energy applied to the precipitated particles (e.g., soot, for example) may be limited by the power supply of the energy application system (e.g., power supply 2012). The processor (e.g., processor 2030) may be configured to control the application of the maximum power the power supply is configured to supply. Alternatively, processor 92 may control the power supply to supply less than the maximum power, for example according to the value indicative of energy absorbable in the precipitate particles or converter core. The EM energy application may be adjusted according to method 550, for example, illustrated in FIG. 5C or any of the other methods described herein. Optionally, the power applied may be determined according to other parameters for example the speed of the car, the angular velocity of the engine, a traveling distance and other parameters or any feedback indicative of pollution emissions received (e.g., detected) from the vehicle and/or the engine.

In some embodiments, the power supply may supply EM energy at a single RF frequency to device 600, for example, the power supply may include a magnetron or a solid state amplifier. In other embodiments, the power supply may supply EM energy at more than one frequency, for example two frequencies, four frequencies or more.

In some embodiments, the amount of EM energy supplied to the radiating elements (e.g., elements 102, and radiating elements 2018, 680 and 685) may be supplied by a capacitor. The capacitor may be charged, for example, from a car battery, or other power source, until a minimum desired amount of energy is charged into the capacitor. In other embodiments, a separate battery may be provided in order to charge the capacitor. In some embodiments, the energy (power) to the amplifiers and/or radiating elements may be supplied directly from the vehicle's battery which may function as a power source. The amounts of applied EM energy may be associated with the first and/or the second target spatial distribution and may be less than 50 kJ. The minimum amounts of energy, discharged in any EM energy application event, may be: 0.5 kJ, 1 kJ, 2 kJ, 4 kJ, 10 kJ, and 50 kJ. The capacitor may be discharged automatically when the minimum desired amount of energy is charged, or controlled, for example by controller 101 or processor 2030, to discharge the energy at a certain moment. Time intervals and time duration for supplying the charged energy (e.g., the energy that was charged on the capacitor) may be determined in similar manner discussed above.

In some embodiments (e.g., according to methods 300, 500, and 550,), EM energy may be applied to oxidize the precipitated particles, e.g. soot particles, at temperatures lower than the combustion temperature of the particles, e.g., soot particles. The combustion temperature of certain types of soot is approximately 650° C. At least one of the time over which the EM energy at the first subset of MSEs, the initial timing of causing application of the EM energy at the first subset of MSEs, or the amount of EM energy applied may be selected such that causing application of the EM energy may heat the soot to 550° C. or less.

EM energy at the first subsets of MSEs may be applied to the soot to cause oxidation of the precipitated particles (e.g., reaction of the soot with air to produce CO2 and H2O) at temperatures lower than: 600° C., 550° C., 500° C., 450° C., 400° C. or lower than 350° C. In some embodiments, the soot may be exposed to EM energy such that oxidation may occur at temperatures lower than the combustion temperature, for example. Applying energy (e.g., by EM source or by other sources), certain period after a first EM energy exposure (e.g., after applying EM energy) may result in oxidation of the precipitated particles, e.g. soot, at temperatures lower than the combustion temperature. The period may be: 1 min, 2 min, 5 min, 10 min or 20 min.

In some experiments testing aspects of embodiments consistent with the present invention, an amount of 2 kJ was charged in a capacitor using a conventional car battery after 2 min. A decision was made to apply the charged energy after 3 min. for a period of 1 s. It was calculated that by applying 2 kJ for 1 s., 20 g of soot was burned. On average, 400 mgr. of soot are produced in 1 KM distance traveling, thus 20 g of soot may be deposited in the filter after 5 KM, wherein 5 KM are traveled in an average driving speed of 100 KMH in 180 s (3 min), thus applying 2 kJ for 1 s every 3 min. may burn 20 g of soot and thus may regenerate and/or clean the filter.

In some embodiments, EM energy may be applied to a soot filter in response to a feedback (e.g., by detecting and measuring) indicative of the amount of soot deposit on the filter. EM energy may be applied to determine a value indicative of EM absorbable in the trapped soot, for example, as discussed above in regards to step 304 in method 300 (FIG. 3). Soot and other hydrocarbons are considered good EM absorbers especially in the RF range. As the amount of soot trapped in the filter increases, the ability of the filter to absorb EM energy may increase, thus may increase the value indicative of EM energy absorbable in the filter. For example, DR for: a clean filter may be 0.1, a filter with 1 g of soot=0.3, with 2 g of soot=0.35 and with 10 g of soot=0.8. In some embodiments, the timing of the EM application and the duration the EM energy is applied, may be determined, for example by processor 2030 according to the changes in the value indicative of EM energy absorbable (e.g., changes in DR). EM energy may be applied after the value indicative of EM energy absorbable reached a threshold that may indicate that a certain amount of soot was trapped in the filter. The detection of the amount of soot trapped in the filter (e.g., by detecting the value indicative of EM energy absorbable) may take place every 0.5 s, 1 s, 2, s, according to signals received (e.g., detected) from the engine or according to any other method designed to detect particles deposition on a filter. Additionally or alternatively, the value indicative of energy absorbable in the soot or converter core may be determined and/or calculated based on, for example: core type, addition of catalytic particles, known characteristics of the soot and/or measurements of the EM energy absorption in soot or a particular converter cores done a-prior to the injection, e.g. during laboratory tests of various cores.

In some exemplary embodiments of the invention, a soot filter (e.g., a cylindrical filter similar to the one illustrated in FIGS. 6B-6D) may include at least two radiating elements. A spatial EM energy distribution may be designed to apply a series of high intensity areas at different locations (e.g., parts or portions) in the filter. The EM energy application may or may not be done sequentially or continuously in time. The EM energy application may cause the hot spots to shift, optionally in a rotational manner, from one location to the other. In order to achieve the shifting in hot spots, a subset of MSEs from among a plurality of MSEs may be selected such that the EM energy may be applied using for example at least one frequency and several phase differences between the EM waves emitted from the radiating elements. Each MSE may include a frequency, amplitude (energy level), the number of radiating element used to apply the EM energy and the phase difference between each pair of radiating elements.

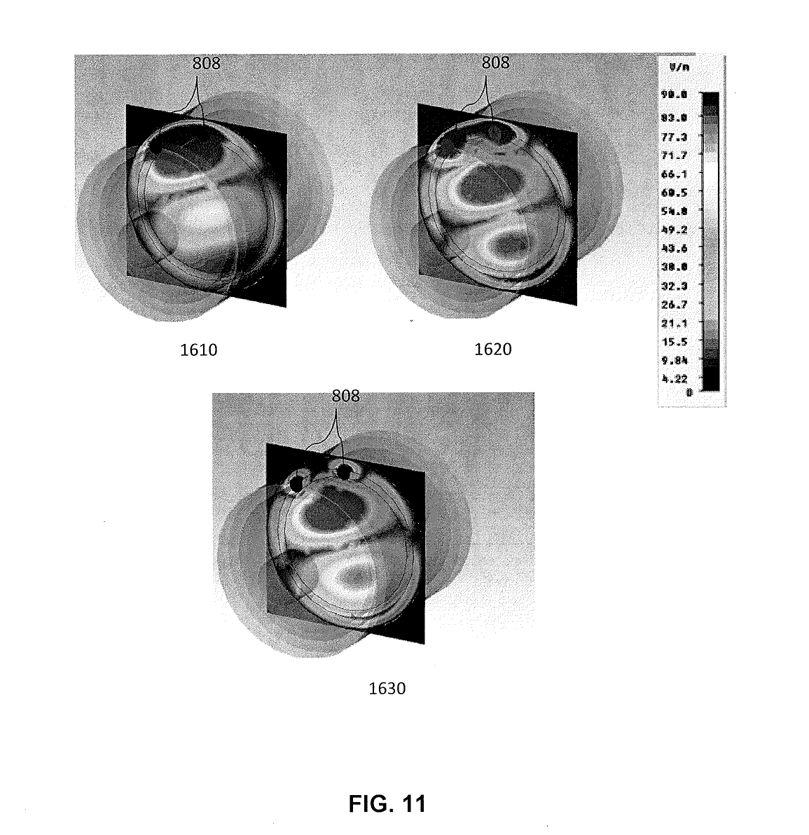

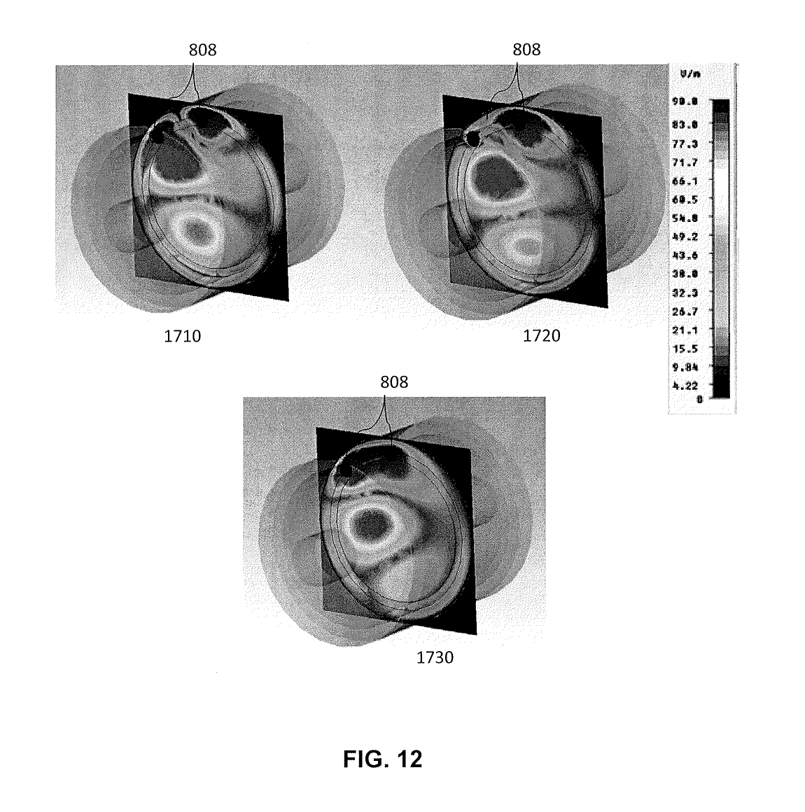

In some embodiments, the EM energy may be applied to an emission reduction device using propagating (traveling) waves. The traveling waves may be emitted at a single frequency or at a plurality of frequencies from any radiating element described herein. The radiating element may include a wave guide, a slotted wave guide, a standard dipole antenna, or any other antenna configured to emit traveling RF waves. The standard dipole antenna may have a total length of λ/2 wherein λ (lambda) is the wave length of the propagating wave in air. In some embodiments, more than one antenna (e.g. standard dipole antenna) may be installed in the energy application zone (e.g., in or near the emission reduction device) and emit traveling RF waves, for example: two antennas, three antennas, four antennas etc. A phase difference may be formed between two waves emitted from two different antennas. In some embodiments, the traveling wave may cause a shift in time-phase of the maximum amplitude (intensity) of the EM field exited in the emission reduction device. Some examples for time-phase shifts in the amplitudes of the EM field are shown in the simulation maps presented in FIGS. 11-13. The time-phase shifts may allow gaining better spatial energy distribution over time in the entire volume of the emission reduction device, for example in a soot filter or a catalytic converter core.

Some aspects of the invention may involve emitting EM waves in a non-resonant cavity. A pollution emission reduction device may include a cavity comprising conductive walls, for example. The device may have dimensions not supporting resonant behavior of the at least one frequency emitted from at least one radiating element (e.g., dipole antenna, or a waveguide). The emitted waves may travel and propagate in the device.

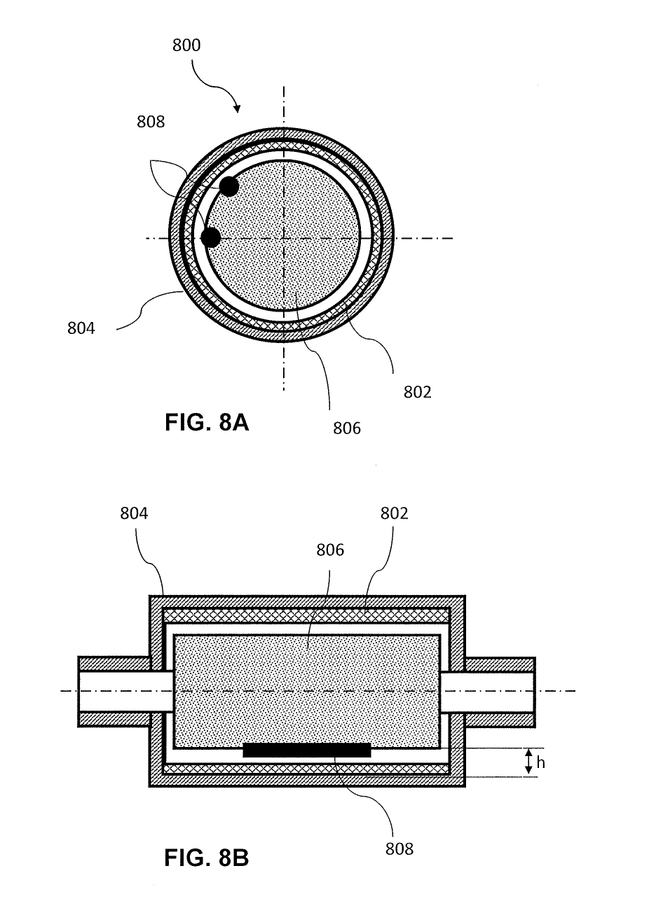

An example of an optional MSE selection may be given using cylindrical filter for example as illustrated in FIGS. 6B-6D and 8A-8B. The cylindrical soot filter may include two radiating elements located in the peripheral area, near the filter. An MSE for applying energy to the filter may include a frequency (e.g., 2.45 GHz, 915 GHz) and a phase difference between the two radiating elements emitting EM waves at the same frequency at the same time (e.g., o, +90 degrees, −90 degrees). Optionally, each MSE may further include the amplitude in which the EM wave is emitted. Applying EM energy using the selected MSEs may cause the maximum intensity (or amplitude) of the EM field excited in the filter to shift and rotate in time, around the filter's central axis, thus applying EM energy to large volume of the filter (e.g., more than 50%, 70% or 90%) in an amount sufficient to regenerate the filter or to accelerate the reaction in a catalytic converter core. In some exemplary embodiments, the EM energy may be applied at a plurality of MSEs to provide EM waves having at least one traveling (propagating) frequency at various phases differences. The propagating waves may cause, for example, a shift in time of the maximum intensity of the EM field, and the phase difference may rotate the location of the maximum intensity in time.

A field pattern that is excited with a wave of a given frequency may be represented mathematically as a linear combination of modes. The modes may include, for example, an infinite number of evanescent modes and a finite number of propagating modes (some of which may be resonant modes). In some embodiments, the evanescent modes may have a very small percent of power (or energy) out of the total power (or energy) used to excite the field pattern, and the vast majority of the total power (and energy) is carried by propagating modes.

In order to control the amounts of energy that are applied to two different regions, it may be desirable to first determine the energy absorption characteristics of the two regions. Differing regions in the energy application zone 9 may have differing energy absorption characteristics, for example, due to different degrees of particulate matter adsorption (e.g., soot or other carbonaceous) on a filter grid or different distributions of catalytic particles in the differing regions of a filter or a catalytic converter, or for other reasons.

In some embodiments, the processor (e.g., processor 92 or 2030) may be further configured to cause differing amounts of energy to be applied to differing portions or regions or volumes of the device based on the distribution of energy absorption characteristics (e.g., according to methods 300, 500, and/or 550). The distribution of energy absorption characteristics may be regarded as a feedback).

In some embodiments, an EM source may be adjusted or controlled (e.g., by a Processor—for example processor 92 or processor 2030) to apply to the pollution emission reduction device (or other device) or a pipeline from the exhaust gas to the pollution emission reduction device or a pipeline from the pollution emission reduction device to the catalytic converter, EM energy at a beta=0 mode (e.g., Kz=0). A beta=0 mode is a mode that does not oscillate in the direction of its z axis, which may be aligned along the pipe. Thus, a beta=0 mode may heat uniformly or substantially uniformly along the z axis, except for power losses that may be caused due to absorption in the soot, exhaust gases or the core. In some embodiments, another radiating element, located at the other side of the pipe may be used to compensate, at least to some extent, for power losses along the pipe. The beta=0 mode may be rotated to improve heating uniformity across the width and breadth of the pollution emission reduction device or the pipe. For this, two or four, for example, radiating elements may be used at each end of the pipe, and the radiating elements may be arranged to apply to the soot in the filter signals or waves that are shifted from each other by 90° time-phase shift. This may create a linearly polarized electric field in a wave that is standing along the radial direction and propagating along the azimuthal direction.

In some embodiments, radiating elements may be positioned along the pollution emission reduction device or the pipe, optionally perpendicularly to the device or pipe. These radiating elements may be matched with the filter or the core such that EM waves entering the pipe are propagating along the pipe. The device itself may be designed to allow uniform field distribution in any cross-section perpendicular to the device central axis. For example, the pollution emission reduction device may include dielectric wall portions that have the same or substantially similar dielectric constant as the filter or the core, in the frequencies used for the heating. Matched loads may be introduced at the ends of the device to prevent EM energy leakage.

In some embodiments, pollution emission reduction devices may include a cavity constructed from conductive material, for example metals such as steel or copper alloys. The conductive cavity may be coated with a dielectric coating having low losses (i.e., low ε). The device may further include at least one radiating element. The radiating element (e.g., standard dipole antenna or a waveguide) may be installed inside the cavity, such that the dielectric coating is located between the conductive cavity and the radiating element. An illustration of a pollution emission reduction device 800 coated with dielectric coating 802 is shown in FIGS. 8A and 8B, in accordance with some embodiments of the invention. FIG. 8A is an illustration of a cross section cut of device 800 and FIG. 8B is a side section of device 800. Device 800 may include cavity 804. Cavity 804 may include at least one conductive section, comprising for example metal. In some embodiments, cavity 804 may be constructed from conductive material (e.g., steel, Cu alloys, Al alloys etc.) or Perfect Electrical Conductive (PEC) material. Cavity 804 may be coated, optionally at the inner side, with dielectric coating 802. Coating 802 may include at least one portion made from material having high losses (e.g., ε′=8.25 and tan δ=0.33). In some embodiments, coating 802 may include a dielectric coating with dielectric properties. For example: if device 800 may be designed to utilize EM energy at a particular frequency for a plurality of frequencies having a central frequency f, coating 802 may be configured to allow waves that propagate from radiating elements 808 to the inner face of cavity 804, to reflect back from the cavity surface at the same phase as the waves emitted from element 808, thus resulting in a wave with doubled amplitude. Coating 802 may include a material having ε=(λ/4h)2, wherein h is the distance between radiating elements 808 and the inner surface of cavity 804 (for example as illustrated in FIG. 8B), and λ is the wave length, in air, corresponding to frequency f.

Device 800 may further include at least one radiating element 808. Two radiating elements are illustrated in FIG. 8A, however any number of elements 808 may be installed in device 800. Radiating element 808 may include any element configured to apply (emit) EM energy to regenerate a filter (e.g., soot filter 806) or catalytic converter core (not illustrated), in accordance with some embodiments of the present invention. For example: element 808 may include standard dipole antenna or a slotted waveguide (e.g., element 685 illustrated in FIG. 6D). Element 808 may or may not be partially embedded in filter 806 (or a converter core). Optionally, it may be substantially (e.g., at least 95% vol.) embedded in filter 806. Filter 806 may include a porous material configured to filter small particles (e.g., soot particles or dust). For example, filter 806 may include SiC, alumina, Silica, a combination of more the one ceramic material or the like. Optionally, an air gap may be provided between filter 806 and coating 802 (as illustrated in FIG. 8A).

In some embodiments, EM energy may be applied to a converter core or a filter via at least one radiating element (e.g., elements 102 and 18 and radiating element 2018, or 680) located in the converter or the filter or outside the converter or the filter comprising a window transparent to EM energy. The radiating element may be configured to apply EM energy at a plurality of MSEs. A processor (e.g., controller 101 or processor 92 or 2030) may be configured to adjust EM energy application to the filter or the converter in order to for example decrease the amount of hazardous compounds in the exhaust gas(es). The processor (e.g., processor 92 or 2030) may determine a value indicative of the energy absorbable in the converter core or the filter. The determined value may change during the operation of the converter due to for examples changes in the temperature of the converter, or the amount of soot deposit in the filter. The processor may determine the value several times during the operation of the engine and/or determine different values (e.g., loss profiles) to different portions of the converter core or the filter. The processor may adjust a desired spatial EM energy profile to be applied to the converter according to the determined value in at least one MSE, for example according to method 500 and 550 illustrated in FIGS. 5A and 5B. The processor may further adjust the timing and/or duration of the EM energy application to the converter or the filter.

In some embodiments, the spatial and/or temporal distribution of the EM energy application to a converter or the filter may be controlled or adjusted in order to obtain, for example, decreased pollution level from the converter or the filter, increased efficiency of the converter or the filter or any combination thereof.

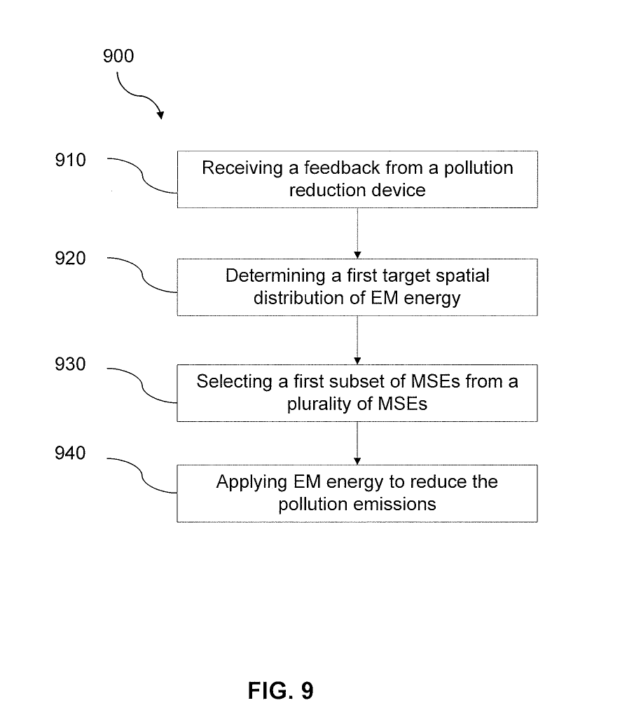

A method for applying EM energy, optionally in the RF range, to a device for reducing pollution emissions (or a convertor core) in accordance with some embodiments of the invention, is presented in FIG. 9. Reducing pollution emissions may be achieved by applying the EM energy to a target material within the device, for example soot trapped in a filter, a filtering element, a converter core or catalytic particles embedded in the core. Method 900 may be conducted by a processor (e.g., processor 92 or processor 2030). Processor 92 may be configured to receive a feedback, in step 910. The feedback may be received from: the device (e.g., the filter or the converter) or from a system comprising the device (e.g., a vehicle). The feedback may be related to at least one aspect of the device or the system comprising the device. The feedback may include information relating to: temperature of the device (e.g., at least one portion of the device), a value indicative of EM energy absorbable in the target material (i.e., an EM feedback—for example: DR), a backpressure of the exhaust gas, a temperature associated with the exhaust gas, a composition of the exhaust gas (e.g., an amount of NOx), or a rotational speed of an engine in fluid communication with the device, etc. The feedback may be related to EM energy absorption characteristics associated with the target material (e.g., the soot), for example: a value indicative of EM energy absorbable in the target material, loss profile etc. The processor may receive feedbacks from one or more sensors, for example: a thermometer, a flow meter may measure the flow of exhaust gasses in the device, a pressure gage may detect the back pressure of the exhaust gasses, etc. In some embodiments, the feedback may include more than one feedback, for example the temperature and the back pressure of the gases. In some embodiments, the feedback may be or include an EM feedback according to some embodiments of the invention. In some embodiments, the EM feedback may be detected by the one or more radiating elements (e.g., elements 680, 685 or 808). The EM feedback may monitor EM aspects of the device that may be related for example to the amount of soot trapped in the filter. In some embodiments, the EM feedback may be indicative of the EM energy absorbable in the target material (e.g., the soot, the filtering element, the core or catalytic particle embedded in the core). The processor may adjust the EM energy application to the device according to the feedback. For example, the processor may determine an amount of energy or power to be applied to the device based on at least one feedback. Additional exemplary methods 300 and 550 for controlling EM energy application based on received feedbacks are disclosed in FIGS. 3 and 5C, respectably.

In some embodiments, the processor may determine a first spatial EM energy distribution for selectively heating a target material associated with a first portion of the device (e.g., in fluid communication with exhaust gas), in step 920. For example, the processor may determine a first spatial EM energy distribution to be applied in order to heat soot particles trapped in a first portion (e.g., part 635) of a filter (e.g., filter 610 or 615). The first spatial distribution may be determined based on the structure of the device (e.g., device 600) and/or the system comprising the device. For example, the first spatial distribution may be determined based on the geometrical shape and dimensions of the device filter or the converter, such that EM energy may be applied to the entire volume of the filter or the converter, or to specific locations (portions) within the converter or the filter. Additionally or alternatively, the first spatial EM energy distribution may be determined based on one or more feedbacks related to at least one aspect of the device or a system comprising the device, for example at least one of the feedbacks received in step 910. The processor may be configured to determine a plurality of EM field patterns through which the EM energy may be to be applied for achieving the first target spatial distribution of EM energy. The processor may be further configured to determine a weight to be applied to each of the plurality of EM field patterns (e.g., according to method 500 shown in FIG. 5A, for example). The processor may determine the first spatial distribution based on a feedback indicative of the location of the soot in a first portion of a filter, a temperature profile in the filter or the core, etc. The processor may determine the first spatial energy distribution based on an EM feedback related to the target material. For example, the EM feedback may be indicative of the amount of EM energy (e.g., in the RF range) that is absorbed by the target material.

In some embodiments, the processor may be configured to select a first subset of MSEs among a plurality of MSEs at which EM energy from the at least one radiating element (e.g., elements 680, 685 or 808) can be applied to the device, in step 930. The processor may select the first subset of MSEs, or at least one MSE based on predetermined calculations or computer simulations, that take into accounts the structure of the device (e.g., devices 600, and 800) and the structure of the EM energy application apparatus (e.g., apparatus 100) installed in the device. The processor may be configured to select the first subset of MSEs such that the selected subset of MSEs being selected to provide at least one spatial distribution of EM energy, for example the first spatial distribution determined in step 920. In some embodiments, the application of the first target spatial distribution of EM energy may be achieved by exciting a propagating EM wave(s) in the device, via the radiating elements. The processor may be configured to select the first subset of MSEs to provide the propagating EM wave(s). Additionally or alternatively, the processor may select the first subset of MSEs based on one or more feedback related to at least one aspect of the device or the system comprising the device, for example, EM feedback indicative of the amount and location of soot trapped in the filter.

In some embodiments, EM energy (e.g., in the RF range) may be applied to the device to reduce the pollution emissions, for example: EM energy may be applied in order to heat the target material (e.g., associated with a first portion) within the device, in step 940. The EM energy may be controlled or adjusted based on one or more of steps 910-930. In some embodiments, the duration at which EM energy is applied at one or more MSEs may be controlled. In some embodiments, the power at which EM energy is applied at one or more MSEs may be controlled. In some embodiments, the processor may be configured to cause the application of the first spatial energy distribution determined in step 940. The processor may further select a subset of MSEs among a plurality of MSEs such that the spatial distribution may be provided. Alternatively, the processor may select the first subset of MSEs from a plurality of MSEs and cause the application of EM energy to the device at the selected MSEs. In some other embodiments, the processor may control the application of EM energy to the device based on a feedback. For example, the processor may determine a first amount of EM energy to be applied to the device (e.g., device 600) based on a feedback related to the temperature of the device. The processor may further be configured to determine the duration at which energy (e.g., power) is applied to the device. The processor may determine the duration of EM energy application at each MSE in the selected first set, such that upon the application of the entire MSEs in the selected first set the determined spatial distribution may be achieved. The process of determining time duration for the application of energy at a particular MSE may be, for example, in accordance to the process of weighting MSEs discussed above, in respect to method 500.

In some embodiments, steps 910-940 may be repeated several times during the operation of the device. The processor may be configured to repeat step 940 and determine a second spatial EM energy distribution to be achieved during application of EM energy to the device for selectively heating a target material associated with a second portion of the device in fluid communication with exhaust gas. Additionally or alternatively, the processor may repeat step 930 and select a second subset of MSEs from among a plurality of MSEs. Optionally, the second subset being selected to provide the second spatial distribution of EM energy determined in the second repetition of step 940. In some embodiments, the application of the second target spatial distribution of EM energy may be achieved by exciting a propagating EM wave(s) in the device, via the radiating elements. The processor may be configured to select the second subset of MSEs to provide the propagating EM wave(s).

The processor may be further configured to determine a plurality of EM field patterns through which the EM energy may be to be applied for achieving the second target spatial distribution of EM energy. The processor may be further configured to determine a weight to be applied to each of the plurality of EM field patterns.

In some embodiments, the processor may be configured to control the timing of the EM energy applications. After a time interval subsequent to the first application of EM energy at the first spatial distribution of EM energy and/or application of EM energy at the first subset of MSEs, the processor may be configured to cause a second application of EM energy at the second subset of MSES and/or to cause the application of EM energy such that the second spatial distribution of EM energy may applied to the target material associated with the second portion of the device. For example, the time intervals between the first and the second EM energy applications may be predetermined (e.g., every 5 sec, 1 min, 5 min, 10 min) or may be determined based on the feedback received from the device. The determining of spatial distribution and/or MSE selection may be repeated each time a change is detected in the feedback, for example: in conjunction with or related to changes in the back pressure of the exhaust gasses, changes in the temperature of the exhaust gasses, changes in the temperature of the core, changes in the rotational speed of an engine in a vehicle comprising the device, changes in the amount and/or composition of the gases emitted from the vehicle, or changes in the loss profile of the target material.

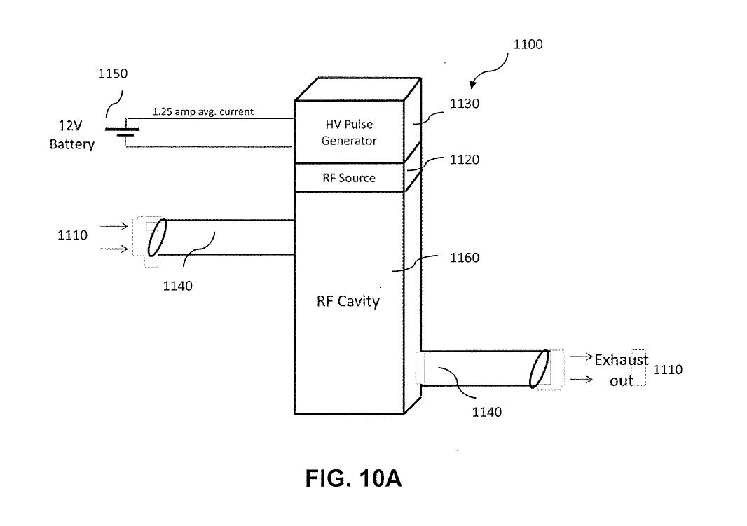

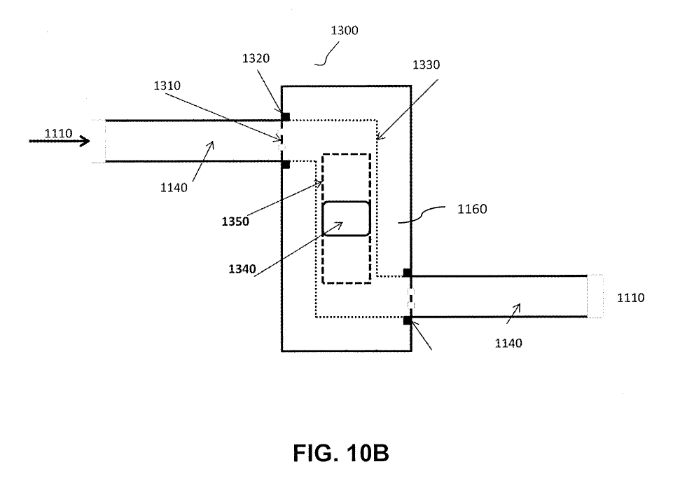

Reference is now made to an exemplary soot filter 1100, according to some embodiments of the invention, illustrated in FIG. 10A. Soot filter 1100, may include a DPF type filter that may include an EM regenerating system designed for burning the soot particles trapped in the filter. Intake exhaust gases 1110 may flow from a diesel (or diesel like) engine and may enter the filter and exit the filter via pipe 1140. The exhaust gases may enter EM cavity 1160. EM cavity 1160 may have a porous ceramic filter or other filter designed to trap soot particles from exhaust gases 1110. The EM regenerating system may include an EM source 1120, for example a magnetron generating an EM energy at a single RF frequency (e.g., 2.45 MHz at 1.7 KW power peak) and a wave guide to apply the RF radiation into cavity 1160. EM source 1120 may be powered by an HV (high voltage) pulse generator 1130 configured to apply energy at pulses every time interval and time duration. HV pulse generator 1130 may include a capacitor. For example, HV pulse generator 1130 may be charged every 3 min. from battery 1150 (e.g., a commercial car battery with a current of 1.25 Amp and a 12V voltage) and then discharge to apply energy to EM source with an energy pulse of 2.7 kJ (2.7 KW for 1 s).

A detailed illustration of EM cavity 1160 is illustrated in FIG. 10B in accordance with some embodiments of the present invention. Intake exhaust gases 1110 may enter and exit cavity 1160 via pipes 1140. At the entrance and the exit to and from cavity 1160, a metal wire mash 1310 may be assembled to block the leakage of RF radiation from the cavity to the environment (e.g., the atmosphere). Additionally or alternatively, RF chocks 1320 may be located around the cavity entrance and exit to block or reduce any EM radiation leakage. Exhaust gases 1110 may flow into low loss tube 1330 that may be constructed for example from heat and shock resistance ceramic material. In approximately the middle section of tube 1330, at least one porous filter 1340, for example a disc shaped silica based filter, may be placed. Filter 1340 may be designed to trap soot particles in exhaust gas flow 1110, according, for example, to regulations imposed regarding soot trapping (e.g., EURO 2 and EURO 5). Filter 1340 may be located or correlated with high intensity EM energy zone 1350. High intensity zone 1350 may be formed by excitation of at least one field pattern according to some embodiments of the present invention. In some embodiments. EM energy may be applied to filter 1340, e.g., by exciting one or more field having high intensity areas in the location of filter 1340.

Some examples of computer simulations for regenerating a soot filter using propagating waves are presented in FIGS. 11-13. The simulations were done using a pollution emission reduction device having structure similar to device 800 illustrated in FIGS. 8A and 8B, wherein radiating elements 808 are installed in the space between filter 806 and coating 802. These and other similar simulations may, for example, be used in the determination of a subset of MSEs appropriate for applying EM energy to a particular object (e.g., in method 550). In the simulation, the filter (e.g., filter 806) was taken to be made of SiC, and two radiating elements (e.g., elements 808) were taken to be standard dipole antennas. The angular distance between the two antennas was 45 degrees. In the simulation, EM energy at a single frequency of 900 MHz was used. The cavity was constructed such that at 900 MHz, the waves propagate and are not resonant. The simulation assumed that the filter was placed in a cavity coated with a dielectric coating designed to cause the reflection of the EM wave from the cavity inner wall towards the filter to be in the same phase as the EM wave emitted from the radiating element, in accordance with some embodiments of the invention. The simulation maps were taken from a cross section at the middle part of the filter. A correlation bar between the different colors shown in the maps and the field intensities (amplitudes) in W/m is given in the right side of FIGS. 11-13.

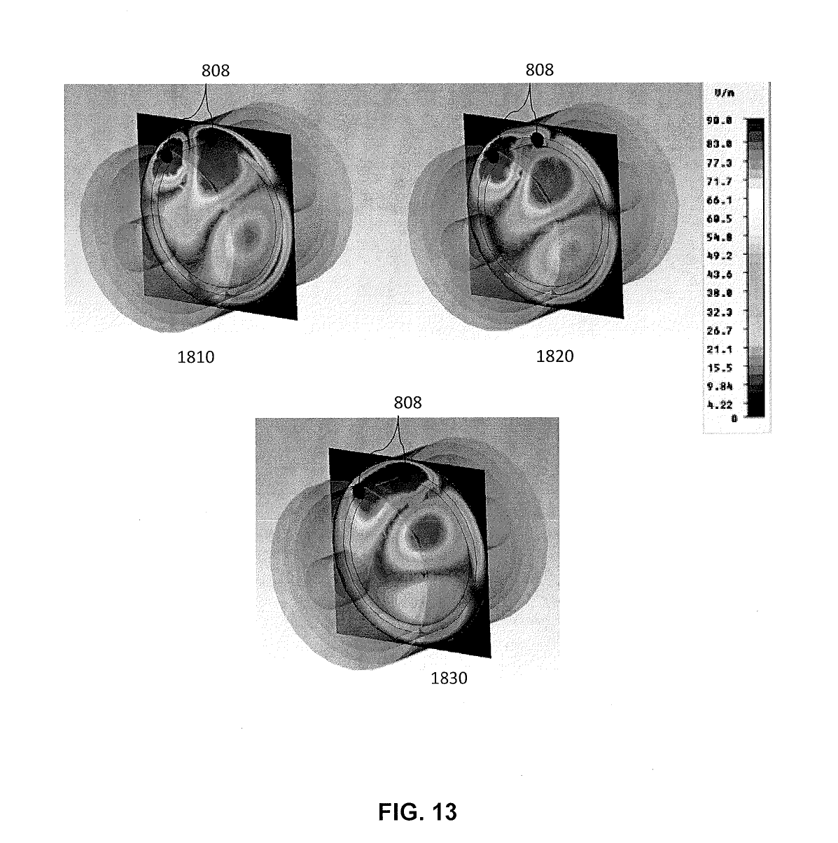

FIG. 11 presents a simulation of EM field intensity maps received when the EM waves emitted from the two antennas had 0 degrees phase difference between them. FIG. 12 presents simulation maps received when the phase between the two emitted waves was +90 degrees, and FIG. 13 presents simulation maps received when the phase between the two emitted waves was −90 degrees. Maps 1610, 1710 and 1810 show the EM intensities at time-phase equal zero (ωt=0), maps 1620, 1720 and 1820 show the EM intensities at time-phase equal 45 degrees (ωt=45°), and maps 1630, 1730 and 1830 show the EM intensities at time-phase equal 90 degrees (ωt=90°). As can be seen, the high intensity areas, or hot spots (marked in dark grey), travel during the propagation of the emitted wave in time, e.g., between ωt=0 and ωt=45°, (in FIGS. 12 and 13, the propagation in time exhibits a rotational behavior). Additionally, the high intensity areas, or hot spots (marked in dark grey), have different initial locations (at ωt=0) between the different phase differences (e.g., between 0 degrees phase difference as illustrated in 1610 and +90 degrees phase difference as illustrated in 1710). The phase shift between the antennas and the propagation in time may result in an EM energy application for regenerating the SiC filter over time.

It is to be understood that, while some embodiments described herein, do not explicitly mention the application of the invention to components in a moving vehicle, any and all methods and apparatuses described herein may be so applied. More specifically, any of the filters, converters or other components (e.g., filter 615 of FIG. 6B or filter 2060 of FIG. 4C, for example) may be mounted in the vicinity of an engine powering a vehicle and methods 300, 500, 550 and/or 900 be applied to the filters, converters or other components while the vehicle is in motion. In addition, or in alternative, methods 300, 500, 550 and/or 900 may be applied to other components in a moving and/or stationary vehicle.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment of the invention.

Moreover, it will be apparent to those skilled in the art from consideration of the specification and practice of the present disclosure that various modifications and variations can be made to the disclosed systems and methods without departing from the scope of the invention, as claimed. For example, one or more steps of a method and/or one or more components of an apparatus or a device may be omitted, changed, or substituted without departing from the scope of the invention. Thus, it is intended that the specification and examples be considered as exemplary only, with a true scope of the present disclosure being indicated by the following claims and their equivalents.

1. An apparatus for applying Radio Frequency (RF) energy to an exhaust treatment device, the apparatus comprising:
at least one radiating element positioned to apply RF energy to the device in accordance with a plurality of sets of values of controllable parameters of the apparatus which affect a field pattern in an energy application zone;
at least one processor configured to:
determine a first spatial distribution of RF energy to be achieved during application of RF energy to the device for selectively heating a target material associated with a first portion of the device in fluid communication with exhaust gas; and
cause application of RF energy, such that the first spatial distribution of RF energy is applied to the target material.

2. The apparatus of claim 1, wherein determining the first spatial distribution of RF energy is based on feedback.

3. (canceled)

4. The apparatus of claim 2, wherein the feedback is related to at least one of a temperature of the device, a value indicative of electromagnetic (EM) energy absorbable in the target material, a backpressure of the exhaust gas, a temperature associated with the exhaust gas, a composition of the exhaust gas, or a rotational speed of an engine in fluid communication with the device.

5. The apparatus of claim 2, wherein the feedback is EM feedback.

6. The apparatus of claim 5, wherein the EM feedback is indicative of EM energy absorbable by the target material.

7. The apparatus of claim 1, wherein the processor is further configured to:
select a first subset of sets of values from among the plurality of sets of values, the first subset of sets of values being selected to provide the first spatial distribution of RF energy; and
cause the application of RF energy with the first subset of sets of values, via the at least one radiating element.

8. The apparatus of claim 1, wherein the target material comprises particulate matter collected at the first portion of the device.

9. The apparatus of claim 8, wherein the first portion of the device comprises a filter for filtering emissions from the exhaust gas or a catalytic core for chemically converting emissions in the filter or catalytic core.

10. The apparatus of claim 9, wherein the at least one radiating element is embedded in the filter or the catalytic core.

11. (canceled)

12. A vehicle comprising at least one apparatus according to claim 1.

13. The apparatus of claim 1, wherein the processor is further configured to:
determine a second spatial distribution of RF energy to be achieved during application of RF energy for selectively heating a target material associated with a second portion of the device in fluid communication with the exhaust gas; and
after a time interval subsequent to the application of RF energy at the first spatial distribution of RF energy, cause application of RF energy, via the at least one radiating element, such that the second spatial distribution of RF energy is applied to the target material associated with the second portion of the device.

14. The apparatus of claim 13, wherein the processor is further configured to adjust the time interval based on a feedback.

15. (canceled)

16. (canceled)

17. The apparatus of claim 14, wherein the feedback is at least in part related to at least one of a value indicative of EM energy absorbable by the target material associated with the first portion of the device or a value indicative of EM energy absorbable by the target material associated with the second portion of the device.

18. The apparatus of claim 13, wherein the processor is further configured to:
select a second subset of sets of values from among the plurality of sets of values, the second subset of sets of values being selected to provide the second spatial distribution; and
after a time interval subsequent to the application of RF energy at the first spatial distribution of EM energy, cause application of RF energy at the second subset of sets of values, via the at least one radiating element.

19. The apparatus of claim 18, wherein causing application of the RF energy at the first spatial distribution is conducted for a first time duration and causing application of the RF energy at the second spatial distribution is conducted for a second time duration.

20. The apparatus of claim 19, wherein the first time duration being based on a feedback from the target material associated with the first portion of the device and the second time duration being based on a feedback from the target material associated with the second portion of the device.

21. (canceled)

22. (canceled)

23. The apparatus of claim 13, wherein:
causing application of RF energy at the first spatial distribution allows the target material to facilitate a chemical reaction with emissions in the exhaust gas at a first rate; and
causing application of RF energy at the second spatial distribution allows the target material to facilitate the chemical reaction with emissions in the exhaust gas at a second rate, the second rate being different than the first rate.

24. The apparatus of claim 13 wherein at least one of the first portion of the device or the second portion of the device comprises a filter.

25. The apparatus of claim 24, wherein at least one of the target material associated with the first portion of the device or the target material associated with the second portion of the device comprises soot particles trapped by the filter.

26.-31. (canceled)

32. The apparatus of claim 9, wherein:
the filter includes a diesel particulate filter (DPF) for a vehicle; and
at least one of a length of time over which the RF energy is applied at the first subset of sets of values, an initial timing of causing application of the RF energy at the first subset of sets of values, or an amount of RF energy applied is based in part on operation conditions of a vehicle.

33-70. (canceled)
